(19) United States
(12) Patent Application Publication
(10) Pub. No.: US 2025/0357676 A1
(43) Pub. Date: Nov. 20, 2025

(54) Systems and Methods with A Planar Cloverleaf Antenna for The Creation of Circularly Polarized Microwave Fields

(71) Applicant: The Trustees of Columbia University in the City of New York, New York, NY (US)

(72) Inventors: Sebastian WILL, New York, NY (US); Ian STEVENSON, New York, NY (US); Weijun YUAN, New York, NY (US); Siwei ZHANG, New York, NY (US); Niccolò BIGAGLI, New York, NY (US)

(73) Assignee: The Trustees of Columbia University in the City of New York, New York, NY (US)

(21) Appl. No.: 18/734,506

(22) Filed: Jun. 5, 2024

Related U.S. Application Data
(60) Provisional application No. 63/471,377, filed on Jun. 6, 2023.
(60) Provisional application No. 63/646,033, filed on May 13, 2024.

(51) Int. Cl. H01Q 15/24; H01Q 3/34; H01Q 7/00

(52) U.S. Cl. CPC H01Q 15/24; H01Q 3/34; H01Q 7/00

(57) ABSTRACT

Disclosed are systems, methods, devices, antenna arrays, and other implementations, including a microwave antenna array that includes a plurality of single loop antennas mounted on a holding structure, and a phase tuner to control the phases of signals radiated (emitted) by each of the plurality of single loop antennas to control polarization of a resultant microwave field generated by the plurality of single loop antennas. In some examples, the plurality of single loop antennas includes four single loop antennas, mounted on the holding structure, to define a cloverleaf shaped antenna array arrangement.

### CROSS-REFERENCE TO RELATED APPLICATIONS

This application claims priority to, and the benefit of, U.S. Provisional Application No. 63/646,033, entitled “SYSTEMS AND METHODS WITH A PLANAR CLOVERLEAF ANTENNA FOR THE CREATION OF CIRCULARLY POLARIZED MICROWAVE FIELDS” and filed May 13, 2024, and U.S. Provisional Application No. 63/471,377, entitled “SYSTEMS AND METHODS WITH A PLANAR CLOVERLEAF ANTENNA FOR THE CREATION OF CIRCULARLY POLARIZED MICROWAVE FIELDS” and filed Jun. 6, 2023, the contents of all of which are incorporated herein by reference in their entireties.

### STATEMENT REGARDING FEDERALLY SPONSORED RESEARCH

This invention was made with government support under CAREER Award No. 1848466 awarded by the National Science Foundation (NSF), and under Award No. N00014-21-1-2721 awarded by the Office of Naval Research (ONR) Defense University Research Instrumentation Program (DURIP). The government has certain rights in the invention.

### BACKGROUND

Microwave fields play a key role in modern technology. In everyday life, numerous applications rely on the emission and detection of microwaves, from microwave ovens to wireless data communication. In quantum science, the active use of microwave fields dates back to the 1930s, when a rapidly oscillating magnetic field was used to control nuclear spins. Recently, the importance of microwave fields in quantum science has rapidly risen. Many high-quality quantum bits (qubits) operate in the microwave regime, including superconducting qubits, nitrogen-vacancy (NV) centers, quantum dots, trapped ions, neutral atoms, and dipolar molecules. The precise control of microwave wavelength, power, and polarization is of paramount importance to generate quantum superposition and entangled states with high fidelity.

### SUMMARY

Disclosed herein are implementations of a cloverleaf microwave antenna array with a high electric field amplitude and a high polarization purity. The implementations feature a compact form factor, ease of manufacturing, and flexible fine-tuning of polarization. The antenna array has successfully been used to realize collisionally stable NaCs ground state molecules, which enabled the first evaporative cooling of ultracold bosonic molecules. More generally, the proposed cloverleaf antenna array implementations facilitate the control of molecular rotational states, which are expected to find applications in quantum simulation and quantum computing thanks to long intrinsic coherence times. In addition, the cloverleaf antenna array may be useful for the implementation of quantum computing schemes with circular Rydberg atoms that require a low ellipticity ξ<2.5° to achieve high fidelity, which is shown herein to be within reach. The proposed implementations are broadly adaptable for microwave quantum state control of atoms, from evaporative cooling of magnetically trapped atoms to the manipulation of atomic hyperfine qubits, as well as other quantum systems that require precise microwave control.

The microwave antenna array can produce microwave fields with extremely pure circular polarization. The proposed implementations allow precise control of circular polarization. Recent work on a number of quantum hardware platforms has shown that there is a need for this to reach high fidelity gate operations in quantum bits (precise polarization suppresses coupling to undesired quantum states). In experiments using the proposed implementations, the requirement of precise circular polarization arose in the context of molecular quantum bits. The proposed implementations can also be used in relation to nitrogen vacancy centers, trapped ions, and potentially other platforms that have quantum states in the microwave domain, such as superconducting qubits. The antenna design of the proposed implementations is extremely compact and ideal for applications that also need optical access with lasers in addition to microwave control (e.g., in situations involving different qubit platforms, for example, trapped ions, neutral atoms, molecules, and also nitrogen vacancy centers). Minor design changes of the antenna allow integration into printed circuit boards or chips, which may open a range of additional applications, for example in cryogenic environments.

Another example use of the antenna array is to achieve operating conditions for Bose-Einstein Condensation. By strongly suppressing two- and three-body losses via enhanced collisional shielding, sodium-cesium (NaCs) molecules can be evaporatively cooled to quantum degeneracy. The BEC reveals itself via a bimodal distribution and a phase-space-density exceeding one. BECs with a condensate fraction of 60(10) % and a temperature of 6(2) nK are created and found to be stable with a lifetime close to 2 seconds.

Thus, In some variations, a microwave antenna array is provided that includes a plurality of single loop antennas mounted on a holding structure, and a phase tuner to control the phases of signals radiated by each of the plurality of single loop antennas to control polarization of a resultant microwave field generated by the plurality of single loop antennas.

Embodiments of the microwave antenna array may include at least some of the features described in the present disclosure, including one or more of the following features.

the plurality of single loop antennas may include four single loop antennas mounted on the holding structure to define a cloverleaf shaped antenna array arrangement.

The phase tuner may include cable length adjusters to control effective lengths of respective cables carrying signals to the plurality of the single loop antennas.

The cable length adjusters can include SMA adapters.

The plurality of single loop antennas can include four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other. The semi-major axes of the first pair of single loop antennas are oriented substantially perpendicularly to the semi-major axes of the second pair of single loop antennas.

When activated, the first pair of opposing single loop antennas can generate a microwave field linearly polarized along a first axis of a three-dimensional space, and the second pair of opposing single loop antennas can generate a microwave field linearly polarized along a second axis of the three-dimensional space.

The phase tuner can be configured to set the relative phase difference between the first pair of opposing single loop antennas and the second pair of opposing single loop antennas to one of −π/2 or π/2 to cause a left circular polarization of the microwave field generated by the microwave antenna array.

In some variations, a microwave field generating system is provided that includes a microwave antenna array including a plurality of single loop antennas mounted on a holding structure, and a phase tuner to control the phases of signals radiated (emitted) by each of the plurality of single loop antennas to control polarization of a resultant microwave field generated by the plurality of single loop antennas. The microwave field generating system further includes a microwave field controller to control properties of (input) microwave signals provided to the phase tuner.

Embodiments of the system may include at least some of the features described in the present disclosure, including at least some of the features described above in relation to the microwave antenna array, as well as one or more of the following features.

The plurality of single loop antennas may include four single loop antennas mounted on the holding structure to define a cloverleaf shaped antenna array arrangement.

The phase tuner can include cable length adjusters to control effective lengths of respective cables carrying signals to the plurality of the single loop antennas.

The plurality of single loop antennas can include four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other. The semi-major axes of the first pair of single loop antennas are oriented substantially perpendicularly to the semi-major axes of the second pair of single loop antennas.

The microwave field controller may include a microwave generator to generate a microwave signal, a voltage-controlled attenuator to control a voltage level of the microwave signal to produce a voltage-controlled microwave signal, a microwave switch with at least one input port to receive the voltage-controlled microwave signal and at least one output port to controllably provide an output microwave signal for downstream transmission of the voltage-controlled microwave signal, and a splitter to split the output microwave signal into a plurality of paths for the respective ones of the plurality of single loop antennas.

The phase tuner may include adaptors to control effective lengths of respective cables carrying signals to the plurality of the single loop antennas, and amplifiers to amplify each of the signals transmitted to the plurality of single loop antennas.

The system may further include a target sample on which the resultant microwave field is applied

In some variations, a method for producing microwave radiation (emissions) is disclosed that includes generating a microwave signal, splitting the microwave signal into a plurality of signals directed to a plurality of single loop antennas, and controlling respective phases of the plurality of signals directed to the plurality of single loop antennas to control polarization of a resultant microwave field generated by the plurality of single loop antennas.

Embodiments of the method may include at least some of the features described in the present disclosure, including at least some of the features described above in relation to the microwave antenna array and the system, as well as one or more of the following features.

Splitting the microwave signal into the plurality of signals directed to the plurality of single loop antennas may include splitting the microwave signal into four signals directed to four single loop antennas, mounted on a holding structure, defining a cloverleaf shaped antenna array arrangement.

Controlling the respective phases of the plurality of signals can include controlling the phases of the plurality of signals to produce a circularly-polarized σ⁺ field applied to a sample of molecules in a magnetic trap.

The method may further include generating another microwave signal, splitting the other microwave signal into another plurality of signals directed to another plurality of single loop antennas to produce a linear π field at a desired orientation relative to the σ⁺ field, and applying the linear π field, together with the circularly-polarized σ⁺ field, to the sample of molecules to suppress collisional losses in the sample of molecules so as to cause evaporative cooling of the sample of molecules that produces Bose-Einstein condensate of at least some molecules in the sample of molecules.

The method may further include applying the circularly-polarized σ⁺ field to a bosonic gas sample comprising strongly dipolar NaCs molecules to achieve low inelastic loss rates for the bosonic gas sample.

Splitting the microwave signal into the plurality of signals directed to the plurality of single loop antennas can include splitting the microwave signal into four signals directed to four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other. The semi-major axes of the first pair of single loop antennas can be oriented substantially perpendicularly to the semi-major axes of the second pair of single loop antennas.

Other features and advantages of the invention are apparent from the following description, and from the claims.

### BRIEF DESCRIPTION OF THE DRAWINGS

These and other aspects will now be described in detail with reference to the following drawings.

FIG. 1A is a diagram of a single loop antenna.

FIG. 1B is a diagram of a cloverleaf-shaped arrangement of a four loop antenna array.

FIG. 1C includes diagrams illustrating different operational modes/configuration of example arrays.

FIG. 1D is a block diagram of a microwave chain to power and control the antenna array(s) of FIGS. 1B-C.

FIG. 2A includes diagrams showing the geometry and relative field strength of a loop antenna array and a helical antenna, that were used in simulations investigating characteristics of a loop antenna array.

FIG. 2B includes a graph showing the amplitude of the total electric field along the axial direction z measured from the top of a loop antenna array and a helical antenna.

FIG. 2C includes a graph showing the radial amplitude profile for the antenna designs of FIGS. 2A-B.

FIG. 2D is a plot showing the calculated directivity for both antenna implementations, with the axial z-direction corresponding to 90°.

FIG. 3A is a schematic diagram of an experimental set up for investigating ultracold NaCs ground state molecules.

FIG. 3B is a graph illustrating fast Rabi oscillations on the σ⁺ transition.

FIG. 3C includes graphs showing Rabi Oscillation at different microwave field polarizations.

FIG. 4A includes a diagram showing microwave shielding of NaCs molecules.

FIG. 4B is a diagram showing the rotational levels of NaCs at 864 G.

FIG. 4C includes a graph plotting the energy splitting between the dressed states (e.g., |+ [symbol] and |− [symbol] ) as a function of Rabi frequency.

FIG. 4D is a graph showing the effective dipole moment, d_{eff}, as a function of Δ/Ω.

FIG. 4E includes a graph with potential energy curves of a pair of microwave-dressed molecules approaching in the s-wave channel.

FIG. 5 includes graphs showing lifetime data of unshielded and shielded molecules.

FIG. 6 includes diagrams illustrating evaporative cooling of NaCs molecules from a thermal cloud to a Bose-Einstein-Condensate (BEC).

FIG. 7 includes block diagrams depicting microwave field generating chains for a circularly polarized (σ⁺) and a linearly polarized (π) microwave fields.

FIG. 8 is a flowchart of a procedure for generating and applying microwave fields with desired characteristics.

Like reference symbols in the various drawings indicate like elements.

### DESCRIPTION

The proposed implementations described herein relate to a phased-array microwave antenna comprising, in one example, four loop antennas arranged in a cloverleaf shape. The proposed antenna is planar and provides high optical access. Its polarization can be flexibly tuned by adjusting the relative phases between the loops. For example, the array can be optimized for left-circular polarization in the near field to, for example, drive a rotational transition of sodium-cesium (NaCs) molecules. During experimentation and evaluation of implementations of the proposed antenna array, strong microwave coupling was observed with a Rabi frequency of 2π×46 MHz, corresponding to an electric field of 33(2) V/cm. The proposed microwave antenna array can be used in various applications where, for example, circular polarization generated by the antenna is needed. An example of such use application is to reduce collisional shielding in a sample of molecules so as to cause evaporative cooling of the sample of molecules in order to produce Bose-Einstein condensate (BEC) conditions for at least some molecules in the sample of molecules.

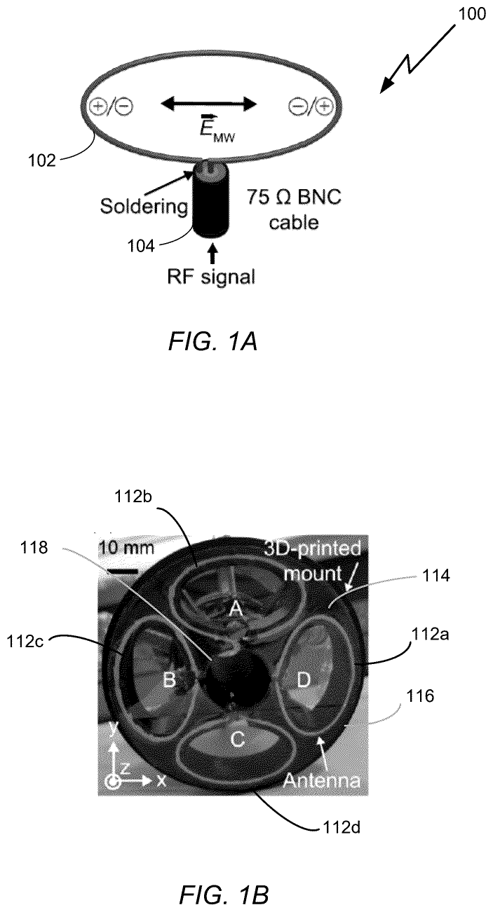

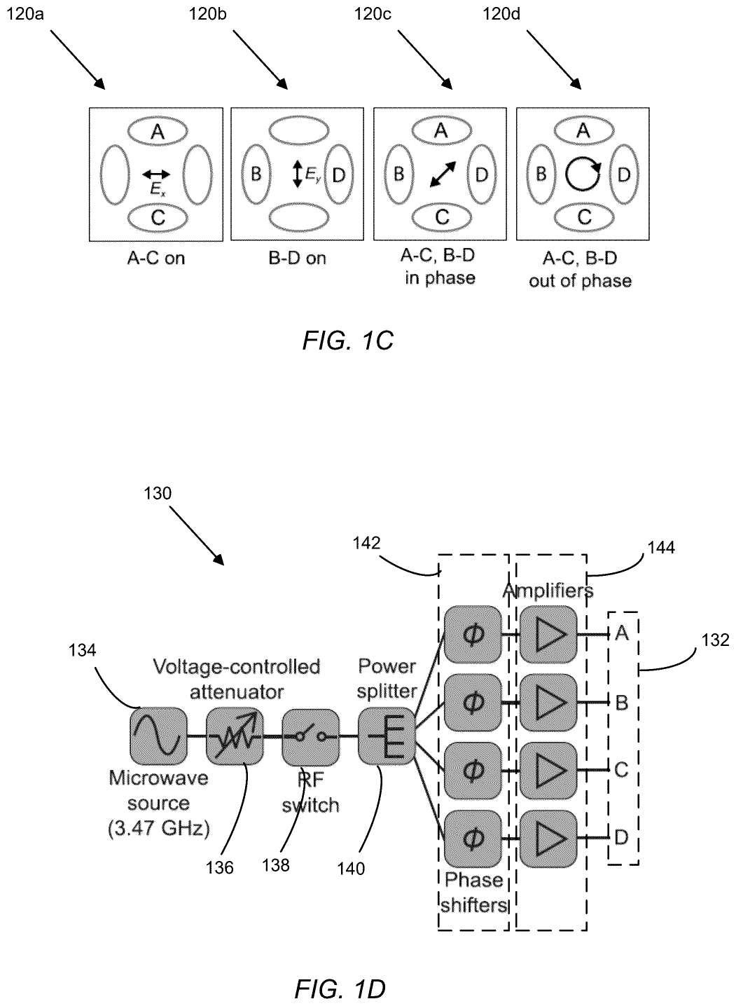

FIGS. 1A-D are diagrams illustrating aspects of the implementation of the microwave antenna array described herein. The proposed antenna array is implemented for an operating frequency of, for example, 3.47 GHz, corresponding to an in-vacuum wavelength of 86.5 mm. For such implementations, the near-field operation of the array, corresponding to the working distances from the antenna that are smaller than the emission wavelength, is the main focus. The array includes a plurality (e.g., 4) of elliptical loop antennas that are arranged in a cloverleaf shape (when there are four (4) loops), with all loops generally being oriented in such a way that the array has a fourfold rotational symmetry.

More particularly, FIG. 1A is a diagram of a single loop antenna 100 from the plurality of loop antennas. The loop antenna 100 (and the others of the plurality of loop antennas) includes, for example, a semi-major axis of 16.7 mm and a semi-minor axis of 10 mm (other loop dimensions may be used instead, based on the specific application for which antenna array is to be used). The circumference 102 of the loop antenna 100 is, for example, 86.5 mm (here too, other dimensions may be used, depending on the particular application that the array comprising a plurality of loop antenna is intended for). The individual loop antennas may be made of 75Ω coax BNC cables in which the jacket and the inner insulator are peeled off to expose the inner copper wire on a length that is slightly longer than one wavelength in vacuum. The copper wire is bent into, for example, an elliptical shape, and its end is soldered to the braided metal shield 104 of the coax cable to form a loop.

The impedance of the resulting one-wavelength antenna in the array has a real part of 100Ω with an additional imaginary contribution. To impedance-match the loop antenna to the 50Ω microwave system, a quarter wavelength transformer and stub-tuning can be used. The quarter-wavelength transformer changes the real part of the antenna impedance to 50Ω. The transformer can be implemented by leaving the length of the unstripped part between the loop antenna 100 and the BNC connector to be 5/4 of the wavelength in the 75Ω BNC cable. An open circuit tuning stub can be used to cancel the imaginary part of the impedance. For example, a T-adaptor can be inserted between the 75Ω cable and the 50Ω cable that comes from microwave amplifiers (as more particularly shown in FIG. 1D discussed below). This setup suppresses the reflections from the antenna by about 10 dB. A bandwidth of 40 MHz is measured for a single loop antenna with the above characteristics and dimensions.

FIG. 1B is a diagram 110 of a cloverleaf-shaped arrangement of a four loop antenna array (marked as loop antennas 112a-d) that may each be similar to the loop antenna depicted in FIG. 1A (it is again noted that the specific dimensions and materials of the loop antenna may vary from one implementation to another as needed for the particular use application contemplated). As further shown in FIG. 1B, a mount 114, such as a 3D-printed structure, made, for example, of PETG plastic is used to hold in place the four loop antennas 112a-d. The example mount includes a shell, whose bottom opening is shown as a circular rim 116. In example embodiments of the antenna array illustrated in FIG. 1B, each of the loop antennas 112a-d is wrapped in white Teflon tape for insulation. The bottom of the antenna mount can be covered by Kapton tape to protect the viewport of the vacuum chamber that the antenna array is mounted on. The mount 114 also includes a hollow central tube 118 through which laser beams can propagate. The hollow tube can have, in some examples, a diameter of about 20 mm. The antenna array can be, in some embodiments, less than 1 mm thick.

Each loop antenna (112a-d) generates a linearly polarized microwave field oscillating along its semi-major axis. By controlling the application of RF signals to the antenna array in different ways or configurations, the polarization of the array can be flexibly tuned. For example, with reference to FIG. 1C, diagrams are provided illustrating different operational modes/configurations of each of antenna arrays 120a-d, which may each be similar to the four cloverleaf loop antenna array of FIG. 1B. Each antenna array comprises four loop antennas that may each be similar to the loop antenna 100 depicted in FIG. 1A). As shown in the diagram having the antenna array 120a, the loop antenna pair A and C generates a microwave field that is linearly polarized along the x (x)-axis, which is denoted by Eₓ. The diagram for the antenna array 120b illustrates the field formed when the antenna pair B and D is activated. Specifically, the loop antennas B and D, whose semi-major axis is oriented perpendicularly (90° angle) relative to the semi-major axes of the loop antennas A and C, generates a microwave field that is linearly polarized along the y-axis. To maximize Eₓ and E_{y} fields generated through the controlled activation of the loop antenna pair A-C and B-D, the phase difference between loops A and C, and B and D, can be set to π.

The polarization of the entire antenna array is controlled by the phase difference between Eₓ and E_{y}. When the antenna pairs A-C and B-D are operated in phase, a 45° linear polarization is generated (as shown in diagram 120c). On the other hand, in order to create right (left)-circularly polarized microwave fields, the phase difference of Eₓ relative to E_{y} may be adjusted to be +π/2 (or −π/2). In some embodiments, the configuration of the antenna array may be optimized for left-circular polarization to maximize coupling to a σ⁺-rotational transition of NaCs molecules (as will be discussed in greater detail below).

FIG. 1D shows the microwave stack (chain) 130 powering and controlling an antenna array 132 (which may be a cloverleaf array such as the arrays depicted in FIGS. 1B and 1C). A microwave generator 134 (e.g., Rohde & Schwarz SMA100B) produces a 3.47 GHz sine wave, whose amplitude can be tuned by a voltage-controlled attenuator 136 (e.g., General Microwave D1954-OPT62) and switched by an RF switch 138 (e.g., Mini-Circuits ZYSWA-2-50DR+). The RF switch includes at least one input port to receive the voltage-controlled microwave signal, and at least one output port to controllably provide an output microwave signal for downstream transmission of the processed voltage-controlled microwave signal. The microwave output signal is then split, using a power splitter 140 (e.g., Mini-Circuits ZN4PD1-63-S+), into a plurality of paths for the respective ones of the plurality of single loop antennas (in the example of FIG. 1D, there are four paths corresponding to the four single loop antennas).

To tune the phases, the effective cable length between the power splitter and the amplifiers can be changed by inserting a stack 142 of, for example, commercial SMA adapters, which act as passive phase shifters. Then, each signal can be amplified by a 15 W amplifier (e.g., Mini-Circuits ZHL-15 W-422X-S+), that in FIG. 1D is represented as a stack of amplifiers 144 whose outputs and connected to respective loop antennas from the array 132. As noted above, T-adaptors may be inserted between each of the cables (e.g., 50Ω cables) connecting the output of the amplifiers of the stack 144, and the 75Ω coax BNC cables comprising the loop antennas in the stack 132, in order to impedance match the amplifiers in the stack 144 to the loop antennas in the antenna stack 132.

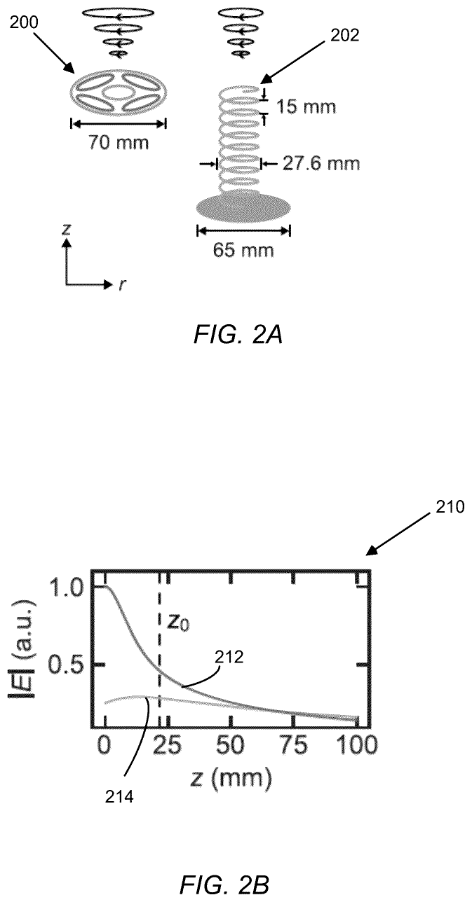

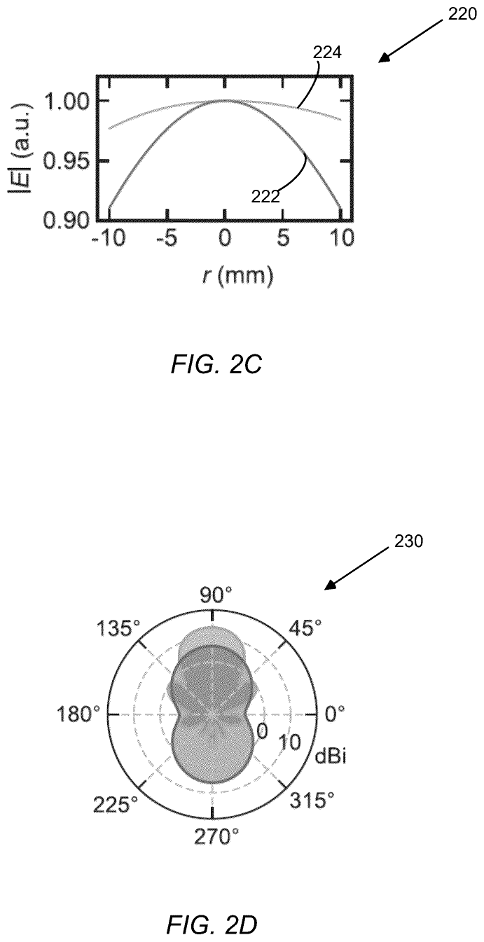

In the course of developing and evaluating the performance of the proposed antenna array, and performance of systems comprising the proposed antenna array, was simulated, mostly focusing on the near-field operation. Using the Antenna Toolbox in MATLAB, radiation patterns were computed. For comparison, a helical antenna was also considered. Helical antennas naturally produce circularly polarized microwaves when operating in axial mode, and have been widely used in atomic and molecular physics experiments, making them a good standard for comparison. The parameters of the helical antenna are chosen to balance the electric field amplitude and polarization purity. The helical antenna model used was one with ten (10) turns and a pitch spacing of 15 mm. The radius of the helix was set to 13.8 mm and the radius of a reflector disk was set to 32.4 mm. FIG. 2A includes diagrams showing the geometry of the loop antenna array 200 and of the helical antenna 202, as described herein, that were used in the simulation.

FIG. 2B includes a graph 210 showing the amplitude of the total electric field along the axial direction z measured from the top of the antenna(s) for both implementations. Curve 212 is the amplitude of the total electric field produced by cloverleaf antenna array 200, while curve 214 is the amplitude of the total electric field produced by helical antenna 202. As shown in FIG. 2B, for a given total input power, the cloverleaf antenna has a stronger electric field amplitude than the helical antenna. As discussed in greater detail below, at a specific distance of z₀=22 mm, the microwave field produced by the cloverleaf antenna array was 1.6 times larger than the field produced by the helical antenna. Additionally, electric field gradient for the cloverleaf antenna array was larger in the near field.

FIG. 2C includes a graph 220 showing the radial amplitude profile for the two antenna array implementations of FIG. 2A, with the electric field amplitude normalized to the value at position r=0 mm for both antenna implementations. As can be seen, compared with the electrical field generated by the helical antenna (curve 224), the electric field amplitude of the cloverleaf antenna array (curve 222) shows a stronger curvature in the radial direction. FIG. 2D is a plot 230 showing the calculated directivity for both antenna implementations. The axial z-direction corresponds to 90° in this plot. The directivity in the far field of the two antenna implementations shows a marked difference. In the axial direction) (90°, it is 6.2 dBi for the cloverleaf antenna array and 13.4 dBi for the helical antenna, indicating a higher directivity of the helical antenna. Given the symmetry of its configuration, the cloverleaf antenna array emits symmetrically in the forward and backward directions. The electric field amplitude in the far field falls off quickly, and the near-field operation is favored. In addition, the reflection coefficient (S₁₁ parameters) for different microwave frequencies was computed to quantify reflections from the antenna, including the stub tuning. The computation yielded a voltage standing wave ratio (VSWR) 2:1 at a bandwidth of 80 MHz, which is compatible with the measured bandwidth of a single loop antenna.

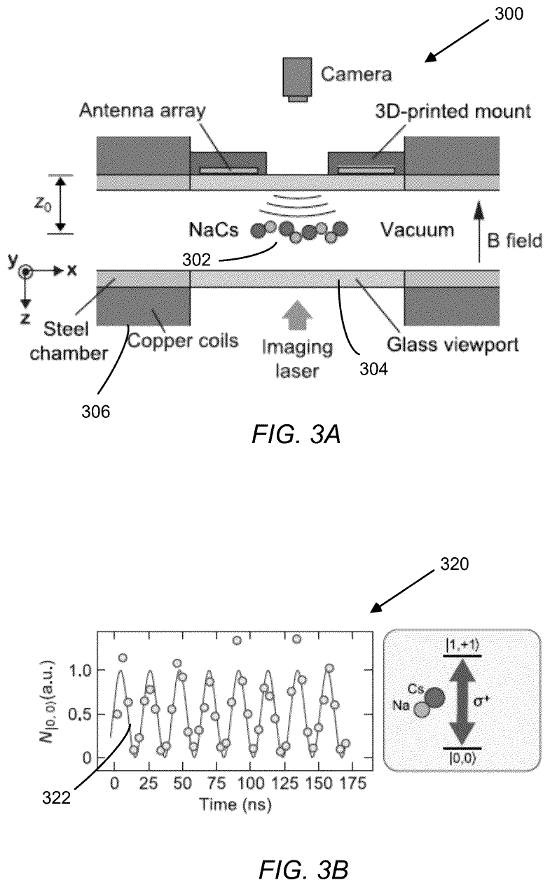

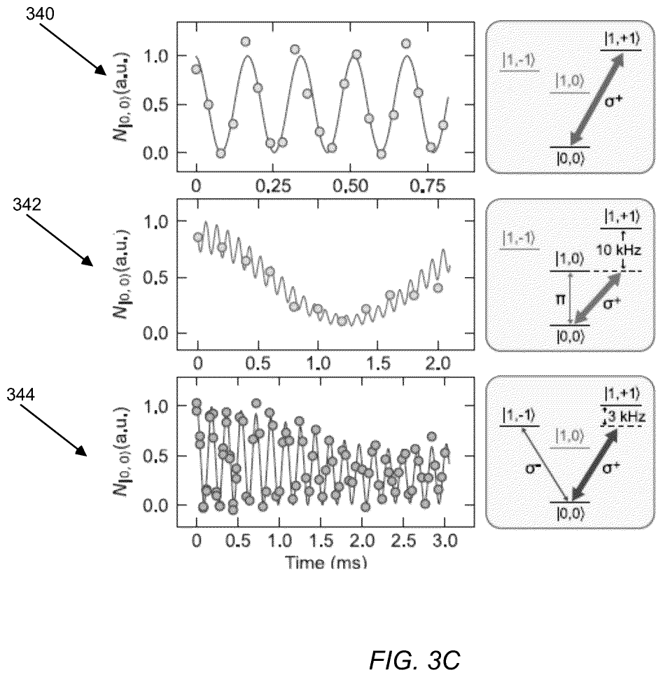

To further analyze the performance of the proposed antenna array, the cloverleaf antenna array was experimentally characterized in terms of electric field amplitude and purity of left-circular polarization. With reference to FIG. 3A, showing a schematic diagram 300 of the experimental set up, ultracold NaCs ground state molecules 302 were employed as an extremely sensitive quantum sensor. The antenna array was mounted directly on a glass viewport 304 of a stainless-steel vacuum chamber, 22 mm away from the molecular sample, surrounded by copper coils 306 that were used to generate homogeneous magnetic fields. NaCs molecules were prepared in the vibrational and rotational ground states, |J, m_{J} [symbol] =|0, 0 [symbol] , where J is the rotational quantum number and m_{J} is its projection on the quantization axis, which is defined by a magnetic field of 864 G along the vertical direction. From |0, 0 [symbol] , three excited rotational states, |1,−1 [symbol] , |1, 0 [symbol] , and |1,+1), can be accessed via an electric dipole transition at a frequency of 3.47 GHz. The left-circularly polarized microwave fields drive the σ⁺ transition to |1,+1 [symbol] . First, the amplitude of the electric microwave field was measured. To that end, the Rabi frequency Ω of the microwave drive, which is related to the electric field amplitude according to E=hΩ/dₜᵣ (where dₜᵣ is the transition dipole moment), can be measured.

To record the data, an example of which is shown in FIG. 3B (providing a graph 320 illustrating fast Rabi oscillations on the σ⁺ transition; the solid line 322 is a sinusoidal fit), a resonant microwave field was switched on, the molecules were allowed to evolve under the microwave field for a variable time, the field was switched off, and the population in state |0, 0 [symbol] was measured. The unusually fast Rabi oscillations between states |0, 0 [symbol] and |1,+1 [symbol] were observed, with a Rabi frequency Ω/(2π)=46.1 (2) MHz, indicating a strong microwave electric field. The transition dipole for the σ⁺ transition is given by dₜᵣ=d_{NaCs}/\sqrt{3}, where d_{NaCs}=4.75(20) D is the permanent electric dipole moment of the NaCs molecules. From this, an electric field amplitude of 33(2) V/cm at a distance z₀ was derived.

In addition, the purity of left-circular polarization was characterized. In the microwave frame, the polarization purity can be quantified by the ellipticity, defined by ξ=arctan (E′₋/E′₊), where E′₋/E′₊ is the ratio of the electric field amplitude proportional to the ratio of Rabi frequencies of the σ^{±}-transitions in the microwave frame. In the lab frame, because the propagation direction of the microwave is not perfectly aligned with the quantization axis defined by the magnetic field, not only can the σ^{±}-coupling to |1,+1 [symbol] and |1,−1 [symbol] be measured, but the π-coupling to |1, 0 [symbol] can also be measured. From the measured data, a coordinate transform to the microwave frame yields the ratio E′₋/E′₊. To achieve a high spectral resolution, the measurements are performed with low microwave intensity.

The resonant Rabi oscillations between |0, 0 [symbol] and |1,+1 [symbol] with Ω₊=2π×5.8(4) kHz was also measured. FIG. 3C includes graphs showing Rabi Oscillation at different microwave field polarizations. Specifically, graph 340 illustrates slow Rabi oscillations on the σ+ transition, graph 342 illustrates slow Rabi oscillation on the π transitions, and graph 344 illustrates Rabi Oscillations on σ⁻-transitions at low microwave power. The solid line in the graph 340 corresponds to sinusoidal fits to extract Ω₊. To extract Ω_{π}, a three-level model is employed to account for off-resonant coupling on the σ⁺ transition manifested as fast jitters on top of the slow oscillation. The solid line in the graph 342 shows the three-level fit. For the σ⁻ transition, a beat envelope is observed due to the interference between the resonant σ⁻-transition and the off-resonant σ⁺-transition. The solid line in the graph 344 shows the three-level fit.

With continued references to the graphs of FIG. 3C, to obtain Ω_{π}, the microwave frequency on resonance with the |0, 0 [symbol] to |1, 0 [symbol] transition is tuned. Fitting the data (in the graph 342) with a three-level model, which takes into account off-resonant σ⁺-coupling, provides Ω_{π}=2π×0.38(7) kHz. Ω₋ is derived by tuning the microwave frequency on resonance with the |0, 0 [symbol] to |1,−1 [symbol] transition (as shown in the graph 344 and its accompanying transition diagram). As the energy splitting between |1,+1 [symbol] and |1,−1 [symbol] is only 3 kHz, the σ⁺ and σ⁻ transitions are simultaneously driven, giving rise to the beat envelope in the data. The data is fitted with a three-level model to yield Ω₋=2π×0.23(2) kHz. From the ratio of Rabi frequencies, the ratio of electric field amplitudes E₋/E₊=0.040(6) is determined, and E_{π}/E₊=0.066(13) in the lab frame. As the phase relations between the electric field components cannot be measured directly, the tilt angle between the propagation direction of the microwaves and the magnetic field cannot be exactly determined. By sampling all possible phases, the tilt angle is determined to lie in the range of 5.1(7)°-5.5(7)°. From this, the ratio of E′₋/E′₊ can be inferred to obtain the ellipticity ranging from 2.1(2°) to 2.4(2)°, corresponding to 2.3(4) °.

Thus, as described herein, key features of the cloverleaf antenna are the compact form factor, its relatively high electric field amplitude in the near field, and the flexible tunability of the output polarization without the need to make physical changes to the antenna itself. This is especially useful for the correction of imperfections, such as reflections and field distortions from boundary conditions in the implementation environment. By tuning the relative phase between the loops, it is possible to switch the antenna from σ⁺ to σ⁻ polarization on demand. This degree of freedom is absent in helical antennas, where the polarization is set by the helicity of the spiral.

A small ellipticity in a challenging experimental environment, with stainless steel and copper structures in the direct vicinity, has been demonstrated. In free space, possibly even smaller ellipticity can be achieved. As noted, the ellipticity for an electric field has been optimized, as the system was used to drive an electric dipole transition. It is worth noting that the polarization purity can also be optimized for magnetic fields as relevant for magnetic dipole transitions. It should also be possible to adapt the design of the antenna, which was implemented here for a resonance frequency of 3.47 GHz, for microwave frequencies in a range from 1 to 20 GHz by adjusting the circumference of the individual loop antennas within practical limits. It should be possible to further improve the performance of the cloverleaf antenna with straightforward modifications. The electric field amplitudes produced by each elliptical loop likely differ by a small amount due to cross-coupling between the loops, asymmetric reflections from the surrounding metal parts, imperfect manufacturing, and/or minor differences in the electronics stack of each loop. By adding amplitude control on the input of each elliptical loop, such inhomogeneities can be compensated and even finer control over the polarization purity could be achieved. Furthermore, it should be possible to increase the directivity of the cloverleaf antenna by adding a reflector that reflects the backward radiation into the forward direction. Simulations show that this can increase the electric field amplitude by a factor of 1.6. In addition, the inclusion of dynamical phase shifters in the electronics stack could further enhance the flexibility of the design. Finally, the form factor and thickness can be further reduced by implementing the antenna as a printed circuit board (PCB). This may also allow for the direct integration into different experimental platforms, including setups in cryogenic environments, reaching beyond the use in atomic and molecular setups.

### 1ₛₜ Example Use Application

As noted, the proposed microwave antenna array can be used in various applications. One such application is the use of a cloverleaf antenna array to generate a microwave shield that reduces molecular/particle inelastic losses within a molecular and/or many-body quantum systems. More particularly, the following discussion relates to the stabilization of a bosonic gas of strongly dipolar NaCs molecules via microwave shielding, decreasing losses by more than a factor of 200 and reaching lifetimes on the order of 1 second. In addition, the use of microwave shielding allows the measurement of high elastic scattering rates, and the characterization of their anisotropy, which arises from strong dipolar interactions. The investigation of the quantum systems described herein also leads to observable evaporative cooling of a bosonic molecular gas. The phase-space density is increased by a factor of 20, reaching a temperature of 36 (5) nK and bringing the system to the brink of quantum degeneracy. The results of experiments using the cloverleaf antenna array to generate a microwave shield constitute a step towards the creation of a Bose-Einstein condensate of dipolar molecules, and opens the door to the creation of strongly correlated phases of dipolar quantum matter.

Quantum statistics has an important role in molecular loss dynamics. Fermionic molecules are intrinsically less prone to inelastic loss than bosonic ones. For indistinguishable fermions, the probability of reaching short range in a two-body collision is suppressed by the p-wave centrifugal barrier. For bosons, such a barrier is absent and the rate of two-body loss is typically one to two orders of magnitude larger than that for fermions. To reduce loss below the natural rate, shielding techniques have been proposed that utilize external electric fields to engineer a repulsive barrier for intermolecular collisions, leveraging the rich internal state structure of molecules. Microwave shielding has been demonstrated in a proof-of-principle experiment for two bosonic CaF molecules in an optical tweezer trap. For bulk gases of fermionic molecules, shielding with D.C. electric fields has been shown for KRb and microwave shielding for NaK, suppressing inelastic loss by about an order of magnitude, sufficient to demonstrate evaporative cooling. Whether loss in bosonic molecular gases can be sufficiently suppressed to enable evaporative cooling has remained an open question. The proposed antenna array described herein allows demonstrating the stabilization of a gas of bosonic sodium-caesium (NaCs) molecules against inelastic loss via microwave shielding. NaCs is strongly dipolar with a permanent dipole moment of d₀=4.75(20) D, making shielding highly effective. During experimentations, the suppression of two-body loss by more than a factor of 200 was observed, increasing the lifetime of dense ensembles, with an interparticle spacing of about 1 μm, from 16(2) ms to 1.0(1) s. The microwave field induces a dipole moment of up to 1.3 D in the laboratory frame, leading to substantial dipolar interactions that enhance elastic collisions. Via cross-thermalization, strong elastic interactions are measured, leading to a ratio of elastic-to-inelastic collisions of up to γ=4(1)×10³. Under these conditions, evaporative cooling of a bosonic molecular gas can be achieved, increasing its phase-space density (PSD) by a factor of 20 and reaching a temperature of 36(5) nK.

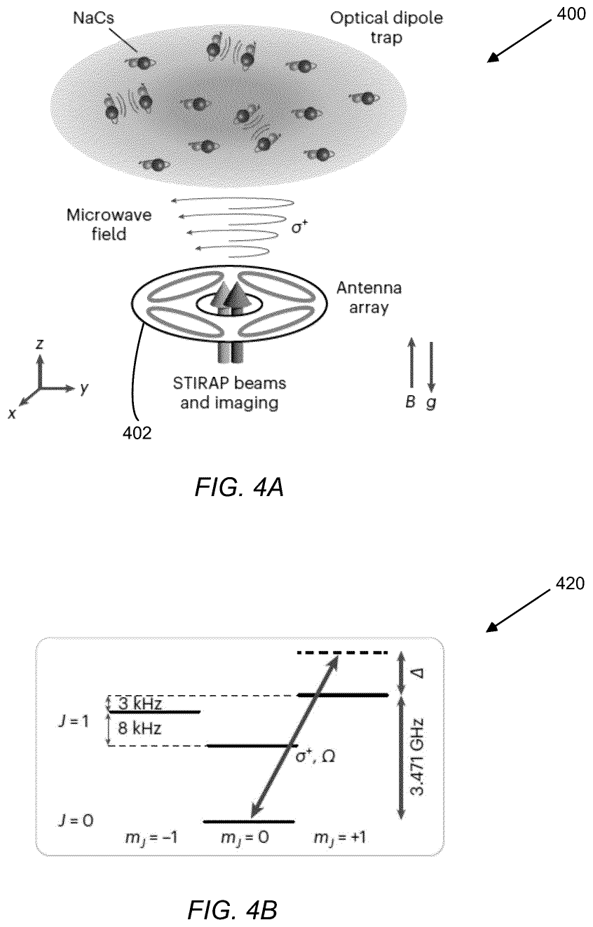

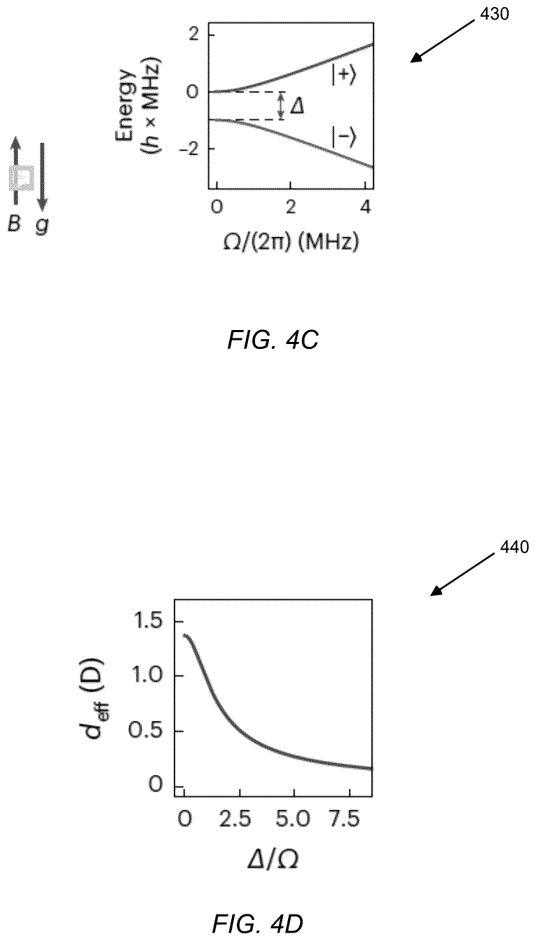

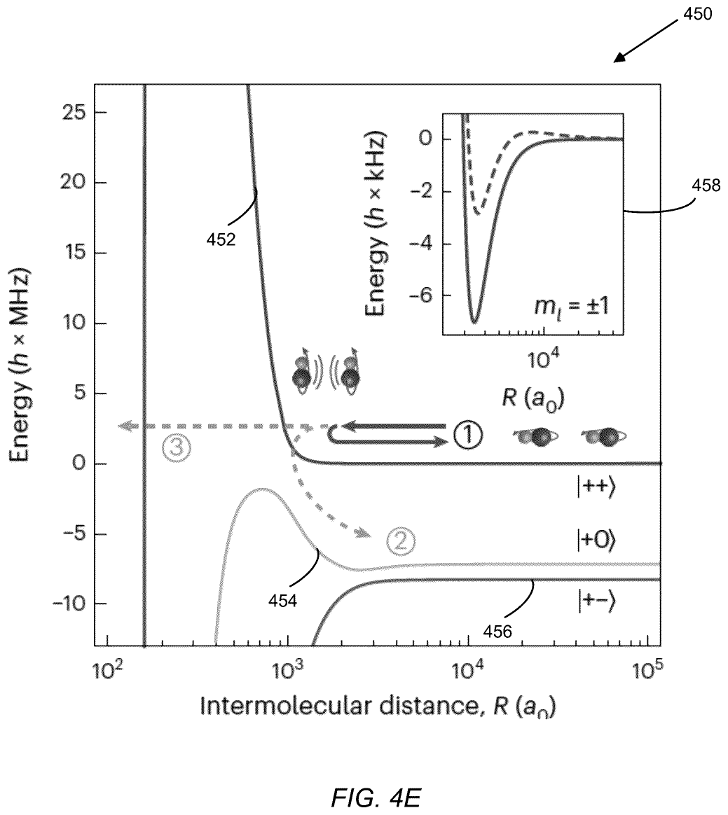

Collisional stabilization is achieved by exposing the ultracold molecular gas to a microwave field with specifically chosen polarization, frequency, and intensity. Initially, the molecules are in the rotational ground state |J, m_{J} [symbol] =|0, 0 [symbol] , where J denotes the total angular momentum excluding nuclear spin, and my denotes its projection onto the quantization axis. Then, a circularly polarized microwave field is applied at a frequency that is blue-detuned by an amount Δ from the resonance ωᵣₑₛ with the excited state |J, m_{J} [symbol] =|1, 1 [symbol] . With reference to FIG. 4A, a diagram 400 showing microwave shielding of NaCs molecules is provided. Molecular dipoles are set into rotation by a σ⁺-polarized microwave field generated by an antenna array 402. Vertical beams for STIRAP allow for time-of-flight expansion of the microwave-shielded gas up to 50 μm cloud waist, enabling precise measurement of temperature. The arrows labelled B and g denote the directions of the magnetic field and gravity, respectively. FIG. 4B is a diagram showing the rotational levels of NaCs at 864 G. The states |J, m_{J} [symbol] =|0, 0 [symbol] and |J, m_{J} [symbol] =|1, 1 [symbol] are split by an energy hωᵣₑₛ with ωᵣₑₛ=2π×3.471323(2) GHz. The microwave field is blue-detuned with respect to the resonance by an amount Δ.

The intensity of the microwave field is adiabatically increased, transferring each molecule into the state |+ [symbol] =cos(ϕ)|0, 0 [symbol] +sin(ϕ)|1, 1 [symbol] , where the mixing angle ϕ is defined by

$$sin ( 2 ϕ ) = 1 / \sqrt{1 + {( 1 + \frac{Δ}{Ω} )}^{2}} ,$$

where Ω denotes the Rabi frequency. The orthogonal dressed state, |− [symbol] =sin(ϕ)|0, 0 [symbol] −cos(ϕ) |1, 1 [symbol] , remains unpopulated. FIG. 4C includes a graph 430 plotting the energy splitting between the dressed states (e.g., |+ [symbol] and |− [symbol] ) as a function of Rabi frequency.

In a semiclassical picture, the dressed states represent dipoles rotating in the x-y plane at a frequency ωres+Δ. Due to the superposition of opposite parity states |0, 0 [symbol] and |1, 1 [symbol] , the dressed states feature an induced dipole moment. The effective dipole moment, d_{eff}, as a function of Δ/Ω is shown in FIG. 4D (graph 440). At large intermolecular distances, shielded molecules interact through a long-range dipole-dipole interaction, expressed as

$${V}_{dd} = {d}_{eff}^{2} ( 3 {cos}^{2} θ - 1 ) / ( 4 {πϵ}_{0} {R}^{3} ) ,$$

where θ denotes the angle between the rotation axis of the dipole and the intermolecular axis, ϵ₀ is the vacuum permittivity and R is the intermolecular distance. When approaching each other, molecules in the |+ [symbol] state mutually align the orientation of their dipoles and repel each other. This is illustrated by the dressed intermolecular potentials shown in FIG. 4E, which includes a graph 450 with potential energy curves of a pair of microwave-dressed molecules approaching in the s-wave channel for Ω/(2π)=4 MHz and Δ/(2π)=6 MHz. The energy curves include adiabatic potentials for |++ [symbol] (curve 452), |+0 [symbol] (curve 454) and |+− [symbol] (curve 456). Molecules are either (1) reflected by the repulsive potential, (2) lost to non-shielded states or (3) reach short range. The inset 458 shows the difference between bosonic NaCs (s-wave scattering, solid line) and a hypothetical fermionic NaCs molecule (p-wave scattering with mₗ=±1; dashed line), where mi is the projection of the angular momentum of the collision) for which the p-wave barrier provides further shielding.

The repulsion prevents the molecules from reaching short range and suppresses loss from inelastic collisions. The shielding efficiency is limited by residual loss channels, such as tunnelling of the molecule pair through the microwave barrier, reaching short range, as well as non-adiabatic transitions to other scattering channels between |+ [symbol] and |− [symbol] and the spectator states |J, m_{J} [symbol] =|1, 0 [symbol] and |J, m_{J} [symbol] =|1,−1 [symbol] , collectively labelled |0 [symbol] .

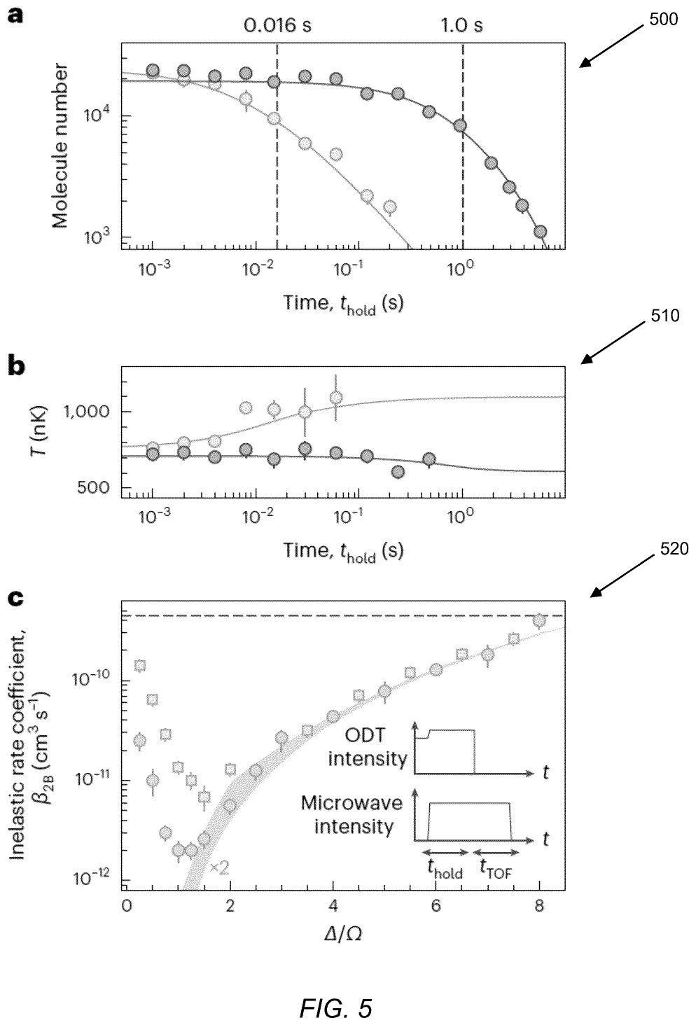

Collisional stability can be demonstrated for gases with 3.0(5)×10⁴ NaCs molecules, prepared in an optical dipole trap (ODT), with an initial peak density of 1.0(2)×10¹² cm⁻³ and an initial temperature of 750(50) nK (details on the sample preparation are provided below). For optimal parameters of microwave shielding, the lifetime of the molecular ensembles increases from 16(2) ms to 1.0(1) s. FIG. 5 shows lifetime data of unshielded and shielded molecules, illustrating this dramatic change. Both the molecule number and temperature as a function of hold time in the ODT, t_{hold}, are tracked, and the data is fitted with a kinetic model that includes one-body, two-body, and evaporative losses. In FIG. 5, the lifetime of molecular ensembles with shielding (dark circles) and without shielding (light circle) are illustrated in graph 500. The dashed lines in that graph indicate the respective 1/e lifetimes. Error bars show 1σ s.e.m. from 10 repetitions of the measurement. The shielded data are taken at Ω/(2π)=4 MHz and Δ/Ω=1. Graph 510 of FIG. 5 illustrates temperature evolution of shielded (dark circles) and unshielded (light circles) samples, corresponding to the data in graph 500. Error bars show the 1σ error from the fit of the time-of-flight expansion. The solid curves in graphs 500 and 510 are fits of the solutions of a kinetic model for molecule number and temperature. Graph 520 of FIG. 5 illustrates the measured inelastic rate coefficient as a function of Δ/Ω at Ω/(2π)=4 MHZ. Circles represent data points taken at 750(50) nK and squares represent data points taken at 160(10) nK. The black dotted line corresponds to the measured two-body loss rate coefficient in the absence of microwave shielding at 750(50) nK. The shaded area shows a coupled-channel calculation for microwave ellipticities between 1° and 5° at 750 nK. The calculation is scaled by a factor of two to highlight the matching trend between experiment and theory. The insets in the graph 520 illustrate the relevant experimental sequence. When shielding is ramped on, the ODT power is adjusted to compensate for the change in a.c. polarizability of the dressed state, ensuring that trap frequencies remain constant. Microwave shielding is kept on during time-of-flight to prevent inelastic losses in the initial phase of time-of-flight. Error bars show the 1σ error from the fit of the loss curves.

Next, lifetime data under different microwave parameters, which allowed the derivation of the two-body loss rate coefficient, β_{2B}, as a function of Δ/Ω. The study was conducted at Ω/(2π)=4.0(4) MHz. This value was chosen after we measured a plateau in the shielding quality as a function of Rabi frequency between Ω/(2π)=4 MHz and Ω/(2π)=10 MHz, with loss rates increasing on either side of this range. The measured loss rate coefficients are shown in graph 520 of FIG. 5. For Δ/Ω>1, the trend of the data agrees well with the results of a coupled-channel calculation that takes into account measured microwave ellipticity of ξ=3(2)°. At Δ/Ω=1, the data shows a 225-fold reduction in the loss rate coefficient compared with the unshielded case, going from β_{2B}=450(50)×10⁻¹² cm³ s⁻¹ to β_{2B}=2.0(5)×10⁻¹² cm³ s⁻¹. For Δ/Ω<1, the data deviate from the theoretical expectations. The data taken at 750(50) nK is compared to a second run at 160(10) nK. While for Δ/Ω>2 the Two Runs are Practically indistinguishable, there is a marked difference for Δ/Ω<2 with a notable uptick of the inelastic rate coefficient for colder temperatures. On the basis of the coupled-channels calculation, which takes into account only two-body physics, such a temperature dependence is not expected. Three-body effects, not accounted for in the calculation, may be a driver of this physics, potentially in conjunction with heating caused by microwave-induced loss.

In addition to the suppression of inelastic collisions, the dipole moment induced by the microwave field enhances elastic collisions. The effective dipole moment depends on the microwave parameters as d_{eff}=d₀{square root over (12(1+(Δ/Ω)²))} (as shown in FIG. 4D), and the resulting dipole-dipole interactions vary as a function of the shielding parameter, Δ/Ω. For example, for small Δ/Ω, the dressed state approaches an equal superposition of |0, 0 [symbol] and |1, 1 [symbol] , leading to a maximal induced dipole moment of d₀/\sqrt{12}≈1.3 D, and an enhancement of the dipolar contribution to the elastic collisions.

As the shielding parameter Δ/Ω is varied, the molecular gas probes two different regimes of dipolar scattering depending on the relative magnitude of the thermal energy, k_{B}T, and the dipolar energy,

$${E}_{d} = {d}_{eff}^{2} / ( 4 {πϵ}_{0} {a}_{d}^{3} ) ,$$

where kB denotes the Boltzmann constant, T the temperature,

$${a}_{d} = {Md}_{eff}^{2} / ( 8 {πℏ}^{2} {ϵ}_{0} )$$

is the bipolar length, M is the molecular mass and h denotes Planck's constant h divided by 2π. The elastic scattering cross-section, σₑₗ, varies in magnitude, temperature dependence and anisotropy depending on which of these energies is dominant. For k_{B}T»E_{d}, collisions are semiclassical and σₑₗ=8πa_{d}/(3k), where k=\sqrt{πMk_{B}T/h} is the thermally averaged collisional wave number. For k_{B}T≤E_{d}, that is, as the thermal deBroglie wavelength, λₜₕ=h/\sqrt{2πMk_{B}T}, approaches or exceeds the length scale of dipole-dipole interactions, the collisional properties are modified and the cross-section enters the threshold regime, becoming σₑₗ=32πa²_{d}/45+8πa²ₛ, where aₛ is the s-wave scattering length of the molecules. Since d_{eff} is a function of Δ/Ω, the experiment accesses both regimes, with k_{B}T≈E_{d} at large microwave detunings, and k_{B}T»E_{d} close to resonance.

The elastic collision cross-section is measured via a cross-thermalization experiment. For these measurements, the peak density is kept below 0.2×10¹² cm⁻³ to avoid entering the hydrodynamic regime, where the thermalization rate would be limited to the mean trap frequency. At constant ODT depth, first a temperature quench is induced by turning off microwave shielding and fast heating due to two-body loss. Then, microwave shielding is turned back on, followed by evaporative cooling and thermalization along the vertical z-axis and cross-thermalization with the x-y plane. During the sequence, the temperature evolution of the cloud in the x-direction can be tracked. Using the kinetic model, the thermalization rate Γₜₕ=σₑₗn̅vₜₕ/N_{col}, where vₜₕ=4\sqrt{k_{B}T/(πM)} is the molecules' mean thermal velocity, n̅ is the mean density of the cloud, and N_{col} is the average number of collisions required for cross-thermalization between the z axis and the x-y plane. A smaller N_{col} means more efficient energy transfer. From Γₜₕ, the elastic scattering cross-section σₑₗ can be determined.

The anisotropic nature of dipolar interactions has a profound impact on the thermalization dynamics via the value of N_{col}. Close to resonance, where the molecular gas is in the semiclassical regime and E_{d} is small, forward collisions that do not deflect the molecules' trajectories by a large angle are favored, thus limiting the transverse energy transfer. More efficient energy redistribution is achieved in the threshold regime at larger detunings, when the induced dipole moment is lower and E_{d} becomes larger. Unlike experiments on fermionic dipoles where there is only the dipole-dipole interaction, bosonic systems also have an s-wave van der Waals contribution to elastic scattering. The scattering length, aₛ, is not known for NaCs and that value can be obtained according to aₛ=1,200 a₀ from a fit to the data (a₀ denotes the Bohr radius). With aₛ being the only free fitting parameter, there is an excellent agreement for σₑₗ between the experiment and a coupled-channel calculation.

From the measured elastic and inelastic collision rates, the ratio of elastic-to-inelastic collisions, γ, is calculated. A peak value of γ≈4(1)×10³ at Δ/Ω=1 is observed. The quantity γ is typically used as a key parameter to characterize the efficacy of forced evaporative cooling. However, evaporative cooling with dipolar elastic collisions in the semiclassical regime is qualitatively different from evaporation in systems with s-wave or threshold dipolar interactions, as is typically the case in atomic and molecular systems, including the recent demonstrations of evaporative cooling in fermionic dipolar molecules. In the present case, the reduced quantity γ/N_{col}, rather than γ, sets the thermalization rate, and thus the evaporation efficiency. The highest value of γ/N_{col}≈250 is still favorable for efficient evaporation.

Evaporative cooling can be demonstrated in the stabilized ultracold gas of NaCs molecules. Starting with a gas at a temperature of 750(50) nK and a PSD of 5(1)×10⁻³. Then, the depth of the ODT is continuously reduced over 1.5 s, while the molecular cloud is shielded at Ω/(2π)=4 MHz and Δ/(2π)=6 MHz. At different stages of the evaporation, the molecule number and temperature are measured, and the PSD of the cloud is derived. At the end of the cooling sequence, a temperature of 36(5) nK is reached and a corresponding PSD of 0.10(3). For small molecule numbers, the measured PSD seems to show a plateau, probably the result of the limited signal-to-noise of the detection system. The extracted evaporation efficiency, −dln(PSD)/dln(N), is 1.0(1), where N denotes the molecule number. This efficiency is similar to that found in recent work on evaporative cooling of fermionic ground-state molecules. Note that besides the prospect of cooling the molecular gas to degeneracy, evaporative cooling allows the preparation of molecular samples at well-defined temperatures over a wide dynamic range, which will facilitate studies of quantum chemistry and collisional physics in bosonic molecular gases.

The various experimental setup aspects will next be discussed. Starting first with sample preparation and detection, NaCs Feshbach molecules were assembled from overlapping ultracold gases of Na and Cs via a magnetic-field ramp across a Feshbach resonance at Bᵣₑₛ=864.1(1) G. The magnetic field points in the vertical z-direction and sets the quantization axis. The samples are held in a crossed ODT with trap frequencies ω/(2π)=(60, 65, 140) Hz (measured for NaCs ground-state molecules). The x dipole trap is elliptical and focused to waists of 127(5) μm (horizontal) and 56(3) μm (vertical); the y dipole trap is circular with a waist of 106(5) μm. Optical trapping light is generated by a 1,064 nm narrow-line single-mode Nd:YAG laser (Coherent Mephisto MOPA). NaCs Feshbach molecules are transferred to the electronic, vibrational and rotational ground state, X¹Σ⁺|v=0, J=0), via stimulated Raman adiabatic passage (STIRAP). Here, v denotes the vibrational quantum number. The specific hyperfine state of the molecules is |m_{INa}, m_{ICs})=|3/2, 5/2 [symbol] , where m_{INa} (m_{ICs}) is the projection of the nuclear spin of sodium (caesium) onto the quantization axis. The STIRAP beams are pointing upwards on the vertical axis. This allows NaCs molecules to undergo time-of-flight expansion while in the ground state in the presence of microwave shielding, which enables precise thermometry.

After time-of-flight expansion, NaCs molecules are detected by reversing STIRAP, optically dissociating them with a pulse of light that is resonant with the Cs 6²S_{1/2}|F=3, m_{F}=3)→6²P_{3/2}|F=4, m_{F}=4 [symbol] transition at high magnetic field, immediately followed by absorption imaging of Cs atoms on the 6²S_{1/2}|F=4, m_{F}=4 [symbol] →6²P_{3/2}|F=5, m_{F}=5 [symbol] transition at high field. Here, F represents the total atomic angular momentum and mr its projection onto the quantization axis.

The temperature of NaCs ground-state molecular gases can be precisely measured using time-of-flight expansion. The basic methodology is similar to temperature measurements of atomic gases, where fitting the increase of cloud radius due to ballistic expansion allows the extraction of in-trap temperature. For molecules, there are subtleties that need to be taken into account to faithfully measure temperature via time-of-flight expansion. The molecules cannot be directly imaged and need to be dissociated before imaging. Dissociation at the beginning of time-of-flight would lead to enhanced losses and systematic shifts in temperature measurement due to a momentum kick from reverse STIRAP and due to the non-adiabaticity of the reverse magnetic-field ramp. Instead, NaCs ground-state molecules are allowed to expand under microwave shielding and dissociate them, right before imaging the constituent Cs atoms. The ability to perform shielding during time-of-flight prevents inelastic loss. For time-of-flight expansion of unshielded ground-state molecules, a systematic overestimation of temperature by about 10% is observed, which is attributed to inelastic loss in the initial phase of time-of-flight. Absorption images yield the column density of the molecular cloud, integrated along the z direction. To derive the cloud size in the x direction, integration along the y direction is performed, and the profile is fitted to a one-dimensional Gaussian,

$$n ( x ) = A {e}^{- {x}^{2} / ( 2 {σ}_{x}^{2} )} ,$$

and the σₓ radius is derived at each time t_{TOF}. The temperature, T, is obtained from the cloud sizes by using the relatior

$${σ}_{x} ( {t}_{TOF} ) = \sqrt{{σ}_{0}^{2} + ( {k}_{B} T / M ) {t}_{TOF}^{2}} ,$$

where σ₀ is the initial cloud radius, k_{B} is the Boltzmann constant and M is the mass of the molecule. An analogous procedure is followed for the y direction, yielding a cross-check of temperature.

Circularly polarized microwave fields are generated with the proposed phased-array microwave antenna discussed herein. As noted, the antenna includes four individual loops, arranged in a cloverleaf-shape, that are one-wavelength resonant for a frequency of 3.5 GHz. Each loop is fed by a 15 W radio-frequency amplifier (MiniCircuits ZHL-15 W-422). The frequency is generated with an ultralow noise signal generator (Rohde & Schwarz SMA100B) that is split into four channels via a power splitter. Each channel is given a differential phase shift of 90° to generate σ⁺ microwave polarization. Before the power splitter, a voltage controlled attenuator (e.g., General Microwave D1954) allows control of microwave power and a stack of three pin-diode switches provides a 135 dB suppression of the source when off. The ellipticity of the resulting microwave is measured to be ξ=3(2) °.

To extract elastic and inelastic loss rates from lifetime data of the shielded molecular gases, a fitting model that includes one-body, two-body and evaporative losses is used. The following coupled differential equations describe the rate of change of molecule number and energy in the molecular gas:

$$\dot{N} = {\dot{N}}_{1 B} + {\dot{N}}_{2 B} + {\dot{N}}_{e v}$$

$$\dot{E} = {\dot{E}}_{1 B} + {\dot{E}}_{2 B} + {\dot{E}}_{e v}$$

The total energy of the gas is E=3Nk_{B}T. The one-body terms take the usual form N_{1B}=−N/τ1B and Ė_{1B}=−E/τ_{1B}, where τ1B is the one-body lifetime. τ_{1B} is measured directly by observing low-density loss curves in which other losses are negligible. The measured value is as low as τ_{1B}≈4.4(4) s for Ω=4 MHz and is kept fixed at this value in the fitting model.

The two-body term in the number differential equation is given by \dot{N}_{2B}=β_{2B}n̅N. Here, β_{2B} is the two-body loss rate coefficient and n̅ is the average density of the molecular cloud. The average density is related to the peak density, n₀, by n̅=n₀/(2√2), where n₀=N(ω̅²M/(2πk_{B}I))^{3/2}, ω̅=(ωₓω_{y}ω_{z})^{1/3} is the mean trap frequency and M is the molecular mass. The two-body loss contribution to the energy differential equation is given by

$${\dot{E}}_{2 B} = - \frac{3}{4} {β}_{2 B} \overline{n} E .$$

The ¾ prefactor originates from integrating the product of the energy density and the number density over the volume of the cloud. A consequence of this is that the molecular gas heats up as a result of two-body loss at a rate \dot{T}=(1/4)β_{2B}n̅E/N, giving rise to anti-evaporation. This can be intuitively understood by noting that two-body loss preferentially takes place in the trap center where the local density is highest, while the energy per molecule in the trap center is smaller (3k_{B}T/2) than the average energy per molecule in the sample (3k_{B}T).

Heating from anti-evaporation is used to realize the temperature quench in the measurement of the elastic scattering cross-section. The effects of evaporation are included via the term \dot{N}ₑᵥ=−Nv(η)Γₑₗ/N_{col}. Here, v(η) is the fraction of elastically scattered molecules with kinetic energy higher than the trap depth and Γₑₗ/N_{col} is the thermalization rate. Γₑₗ is the elastic scattering rate, N_{col} is the number of collisions to produce a 1/e change in the molecule temperature, η=Uₘᵢₙ/(k_{B}T) is the truncation parameter and Uₘᵢₙ is the trap depth.

It is known that v(η)=(2+2η+η²)/(2e^{η}). The elastic scattering rate is Γₑₗ=n̅σₑₗvₜₕ, where σₑₗ is the elastic scattering cross-section and vₜₕ=4\sqrt{k_{B}T/(πM)} is the thermal velocity. Performing a fitting operation, Γₑₗ is capped according to Γₑₗ<ω⁻/(2π), to account for the hydrodynamic limit. As interactions in the gas are highly anisotropic, N_{col} is not a number, but rather a matrix accounting for the number of collisions for thermalization for every pair of trap axes, that is,

$${N}_{col}^{xx} , {N}_{col}^{xy} , {N}_{col}^{xz} ,$$

and so on. In the fitting routine, the product σₑₗ/N_{col} is fitted and then the calculated maximum N_{col} element is used to derive σₑₗ.

The evaporative term in the energy differential equation is:

$${\dot{E}}_{ev} = - \frac{( \frac{1}{3} ) E α ( η ) {Γ}_{el}}{{N}_{Col}} \qquad ( 13 )$$

where α(η)=(6+6η+3η²+η³)/(2e^{η}). (1/3)Eα(η) is the energy of the molecules with kinetic energy larger than the trap depth and Γₑₗ/N_{col} is the rate at which the energy will leave the system.

The differential equations can be recast in the following form:

$$\dot{N} = - N \dot{[ \frac{1}{{τ}_{1 B}} + {β}_{2 B} \overline{n} + v ( η ) {Γ}_{ev} \overline{n} ]}$$

$$\dot{E} = - E \dot{[ \frac{1}{{τ}_{1 B}} + {β}_{2 B} \overline{n} + \frac{1}{3} α ( η ) {Γ}_{e v} \overline{n} ]}$$

where Γₑᵥ=σₑₗvₜₕ/N_{col} for clarity.

Experimentally, the number and temperature of the molecular cloud were measured as a function of hold time. Then the data was fitted with this model to extract the initial number, No, the initial temperature, T₀, β_{2B} and σₑₗ/N_{col}. In practice, cross-thermalization data is first fitted to obtain σₑₗ/N_{col}, and then the lifetime data is fitted using σₑₗ/N_{col} from the first fit.

Thus, in the first example use application involving the proposed antenna array, experimentation has demonstrated that ultracold gases of bosonic ground-state molecules can be effectively stabilized via microwave shielding (achieved by the proposed loop antenna array), reaching low inelastic loss rates similar to shielded fermionic molecules despite the absence of a p-wave barrier. Data on anisotropic cross-thermalization showed that even above quantum degeneracy the strongly dipolar character of the gas used in the experiments leads to non-trivial thermodynamic behavior. Dipolar liquids similarly have recently been predicted to show anisotropic thermal conductivity and viscosity. Owing to the rapid tunability of microwave parameters Ω and Δ, allowing the quasi-instantaneous tuning of inelastic and elastic scattering properties, novel non-equilibrium measurement protocols can be envisioned to probe such thermodynamics. A key question that emerges from the work around the first example use application is whether Bose-Einstein condensation of microwave-shielded dipolar molecules can be achieved. The measured gain in PSD leads us to the brink of Bose-Einstein condensate.

Further reduction of microwave noise and a better understanding of inelastic loss at small detunings may allow reaching even lower loss levels, as predicted by theory. Field-linked resonances, which should be accessible for NaCs at low microwave ellipticity and moderate microwave intensity, allow for independent tuning of a_{d} and aₛ and offer a tuning knob to further improve on the scattering properties of molecules. Using field-linked resonances to tailor interactions may also tune N_{col} close to or below the s-wave value of 2.5, increasing the thermalization rate by an order of magnitude, and enhancing the evaporation.

Starting from shielded three-dimensional bulk samples of bosonic molecules, efficient transfer with minimal loss to lower-dimensional systems comes within reach. In two-dimensional systems, microwave shielding and d.c. electric fields should enable the realization of strongly correlated phases, such as supersolidity and self-organized crystallization of dipoles, both in single layers and multilayers. NaCs molecules are a highly promising platform for such explorations due their large dipole moment, which allows a characteristic range of dipolar interactions, a_{d}, of tens of micrometers. Shielded loading of optical lattices, in particular from a Bose-Einstein condensate of molecules, may offer a way to reach unity filling, necessary to realize extended Hubbard models, and enabling studies of many-body spin models in defect-free molecular arrays.

### 2^{nd} Example Use Applications

Another example use application, in which the proposed microwave antenna array can be used, is for achieving enhanced collisional shielding needed for many-body quantum systems, that in turn establishes the condition for achieving Einstein-Bose Condensation of polar molecules. Quantum degenerate samples of bosonic dipolar molecules promise the realization of novel phases of matter with tunable dipolar interactions and new avenues for quantum simulation and quantum computation. However, rapid losses, even when reduced through traditional collisional shielding techniques, have so far prevented cooling to a Bose-Einstein condensate (BEC). By strongly suppressing two- and three-body losses via enhanced collisional shielding (achieved using the proposed microwave antenna array), sodium-cesium (NaCs) molecules are evaporatively cooled to quantum degeneracy. The BEC reveals itself via a bimodal distribution and a phase-space-density exceeding one.

Quantum gases of ground state dipolar molecules have been proposed as a clean and controlled system in which long range interactions can be tuned from the weakly interacting to the strongly interacting regime. In the limit of weak interactions, bosonic molecules will form a Bose-Einstein condensate, much like dilute atomic clouds. Once the strength of interactions is increased, theoretical predictions abound and include the realization of strongly correlated phases of matter, from supersolids to dipolar crystals and Mott insulators with fractional filling. Thus, low entropy samples of dipolar molecules will constitute a new platform for many-body physics and quantum simulation.

The realization of a Bose-Einstein condensate of dipolar molecules has been elusive for more than two decades, since the first theoretical ideas on their use were explored. When the first ultracold gases of dipolar ground state molecules were created in 2008, it was found that chemical reactions can lead to relatively fast losses which limited their lifetimes. To mitigate such losses, ground state samples of chemically stable species were prepared, but the problem of short lifetimes remained, likely due to loss channels that open up as a result of molecules' complex internal structure and interactions. Such losses prevented efficient evaporative cooling (a workhorse technique in the preparation of atomic quantum gases). Recently, various collisional shielding techniques have led to the production of molecular clouds with reduced losses, but evaporative cooling has remained relatively inefficient. For fermionic molecules, thanks to their intrinsically lower losses, this has been sufficient to create degenerate Fermi gases. Recent work showed that further substantial improvements to collisional shielding are key to reaching quantum degeneracy for bosonic molecules.

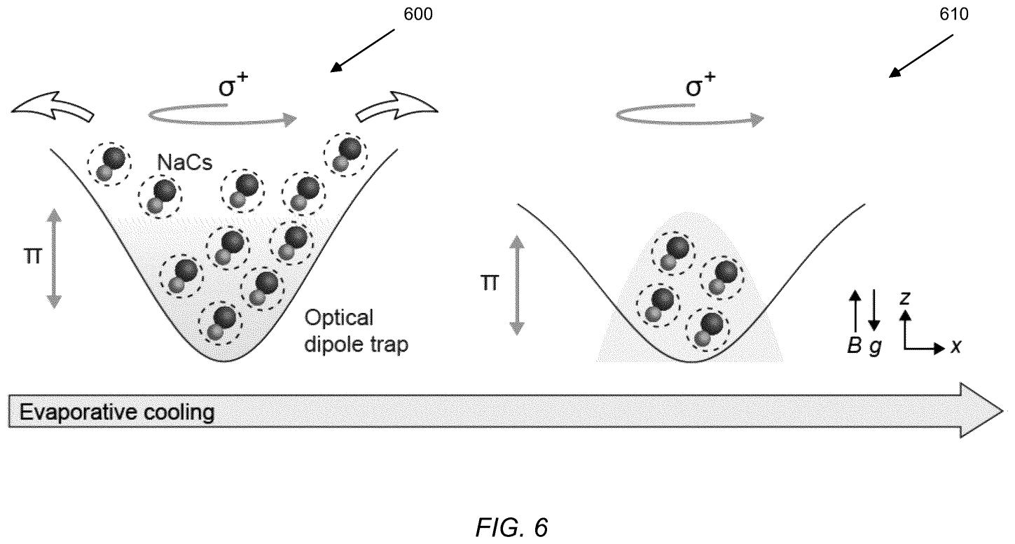

Using the proposed loop antenna array described herein, two- and three-body losses can be strongly suppressed, which, in turn, achieves evaporatively cooled ensembles of NaCs molecules from 700(50) nK to 6(2) nK within, in turn, approximately 3 seconds. FIG. 6 includes diagrams 600 and 610 illustrating evaporative cooling of NaCs molecules from a thermal cloud to a BEC. The molecules are held in an optical dipole trap and dressed by circularly polarized (σ+) and linearly polarized (π) microwave fields. The collisionally stable molecular gas is cooled by lowering the trap depth forcing out the hottest molecules. It is noted that thermal (the diagram 600) and condensed (the diagram 610) gases have different density profiles. The trap depth is lowered by reducing the power of a laser that serves as a so-called optical tweezer that holds the molecules inside a vacuum chamber. The laser operates at 1064 nm wavelength. Its power can be controlled with a acousto-optic modulator that is driven by microwave electronics controlled by a computer system/microcontroller

Critical phase-space density for a BEC is reached with over 2,000 molecules and further evaporate to BECs with 200 molecules and small thermal fractions. In experiments conducted, the BECs were found to be stable, with a 1/e-lifetime of 1.8(1) s. These results show how molecules have achieved a degree of quantum control analogous to that of atoms, drastically expanding the scope of the quantum systems that can be studied.

For efficient evaporative cooling, collisional losses need to be strongly suppressed. To achieve this, the molecules are transferred into a dressed state using two different microwave fields, one with circular σ+-polarization and one with linear x-polarization. Microwave shielding has a fundamental limit to its effectiveness as there is a trade-off between the suppression of two- and three-body losses. The current understanding is as follows: When a single circularly polarized microwave field is employed, a superposition of two rotational states induces a rotating dipole moment. At short range, this forms a strong repulsive barrier that prevents two-body loss, with lower losses the stronger the microwave coupling. At long range, dipole-dipole interactions remain attractive (in the s-wave channel). As a result, at an intermolecular distance of ˜2,000a₀ an attractive potential well appears which supports field-linked bound states when the microwave coupling is strong. These bound states can give rise to loss via three-body recombination, hence the more effective the suppression of two-body loss, the stronger the three-body losses. This sets a lower limit to the achievable loss rates and subsequently caps the efficiency of evaporative cooling.

In order to suppress three-body recombination, field-linked bound states need to be removed while preserving a highly effective suppression of two-body loss. This is achieved by compensating the attractive dipole-dipole interactions at long range while leaving the dipole-induced repulsive barrier at short range unaffected. Dipole-dipole interactions of rotating dipoles induced by a σ⁺ field and oscillating dipoles induced by a π field have the peculiar property to be opposite in sign. By simultaneously dressing the molecules with a circularly- and a linearly-polarized microwave field, the induced dipole-dipole interactions are compensated and minimize the long-range attraction. This allows the engineering of a purely repulsive intermolecular potential, minimizing both two- and three-body losses. A similar compensation of the induced dipole moment can likely also be achieved by combining microwave and electrostatic fields.

In addition to suppressing collisional losses, the microwave dressing scheme helps tuning the molecular interactions to a regime where Bose-Einstein condensation is possible. In the case of bosonic dipolar molecules, interactions include s-wave contact interactions, characterized by the s-wave scattering length, as, and dipole-dipole interactions, characterized by the dipolar length:

$${a}_{dd} = \frac{{Md}_{eff}^{2}}{12 π {ℏ}^{2} {ε}_{0}} .$$

Here, M denotes the mass of NaCs, d_{eff} is the effective dipole moment, ℏ is Planck's constant, h, divided by 2π, and ε₀ is the permittivity of free space. For stable BECs of dipolar particles, the interactions must be repulsive (aₛ>0), weak (n₀a³ₛ«1, and n₀a³_{dd}«1, where n₀ is the peak number density), and the dipolar interactions should be weaker than contact interactions (ε_{dd}=a_{dd}/as<1). For NaCs molecules dressed by a single σ⁺ field that is sufficiently strong to suppress two-body loss, a_{dd} is between about 10,00 and 25,000a₀, making it hard to fulfill these conditions. With the presence of the π field, the dipolar length can be strongly reduced. While in principle the full cancellation of dipolar interactions is possible, in practice what can be achieved is a_{dd}=1,250a₀, due to finite ellipticity of the σ⁺ field, and aₛ˜1,500a₀.

To achieve the conditions for Bose-Einstein-Condensate, the experiment begins with gases of 30,000 NaCs molecules in their electronic, vibrational, and rotational ground state, held in a crossed optical dipole trap at a temperature of 700(50) nK. The molecules are adiabatically prepared in the collisionally-shielded dressed state by sequentially ramping up a circularly-polarized σ+ and a linearly polarized π microwave field. It has been determined that Ωσ=2π×7.9(0.3) MHZ, Δσ=2π×8 MHZ, Ωπ=2π×6.5(0.2) MHz, and Δπ=2π×10 MHz to provide good working conditions for evaporative cooling. Here, Ωσ(Ωπ) and Δσ(Δπ) are the Rabi frequency and detuning of the σ⁺ (π) field.

Forced evaporation was then performed by decreasing the depth of the optical dipole trap from k_{B}×5.3(0.3) μK to k_{B}×40(15) nK within 2.8 s, followed by free evaporation for 400 ms by holding the sample in the low-depth trap. The absorption images of the molecular cloud after time-of-flight expansion are recorded at various points of the cooling sequence. Close to the end of the cooling sequence, observation of the formation of a BEC starts appearing through the emergence of a bimodal density distribution. Analyzing the density profiles of the molecular clouds, it is determined that a bimodal fit captures the shape significantly better than a purely Gaussian fit. For larger condensate fractions, a marked offset along the x-axis is between the center of the thermal and condensed components, potentially caused by trap imperfections or repulsion between the two components in time-of-flight. At the end of the cooling sequence, a BEC is observed with a small thermal cloud surrounding it.

To analyze the cooling process, the phase space density (PSD), temperature, and peak density of the thermal molecular gas were determined at various points of the cooling sequence. The sample starts at a PSD of 5×10⁻³ and the BEC transition is expected at a PSD of 1.202 in a 3D harmonic trap. A PSD of ˜1 was reached at 20 nK with over 2,000 molecules. This aligns with the point where the density profiles show the onset of a bimodal distribution in time-of-flight with a condensed core and a thermal cloud surrounding it. At the end of evaporation, a condensate fraction of 60(10) % is observed for the coldest clouds. From fits to the expansion of the thermal wings, a temperature of 6(2) nK is obtained. Using the data points in the thermal regime, the evaporation efficiency can be determined to be dln(PSD)/d ln(N)=2.0(1). In the course of the evaporative cooling sequence the PSD increases by more than three orders of magnitude, which far exceeds the gains observed in previous demonstrations of evaporative cooling of molecules.

The peak density of the molecular cloud stays approximately constant during the evaporation. In the thermal regime it is around n₀=1.5(3)×10¹² cm⁻³, before slightly increasing to n₀=2.0(5)×10¹² cm⁻³ in the degenerate regime. Compared to atomic BECs, which often reach peak densities above 10¹⁴ cm⁻³, these are unusually low densities, induced by the large value of aₛ. Thanks to these conditions, the system is in the weakly interacting regime n₀aₛ³«1 and n₀a_{dd}³«1, which ensures that quantum depletion is negligible.

Further details regarding the experimental setup, include the use of the proposed antenna array described herein are now discussed. As noted, the experiments conducted included the preparation of ensembles with about 30,000 ground state NaCs molecules at a temperature of 700(50) nK. At the beginning of forced evaporation, the sample is held in a crossed optical dipole trap with trap frequencies ω/(2π)=(45,78,162) Hz (measured for NaCs ground state molecules). The x-dipole trap is elliptical and focused to waists of 108(1) μm (horizontal) and 51.5(5) μm (vertical); the y-dipole trap is almost circular with waists of 117(1) μm (horizontal) and 104.5(5) (vertical). Optical trapping light is generated by a 1064 nm narrow-line single-mode Nd:YAG laser (e.g., Coherent Mephisto MOPA). At the end of evaporation the trap frequencies are ω/(2π)=(23,49,58) Hz.

The ensembles of ground state molecules are prepared in three steps. First, overlapping ultracold gases of Na and Cs atoms are created. Second, weakly bound NaCs Feshbach molecules are assembled via a magnetic field ramp across the Feshbach resonance at Bᵣₑₛ=864.1(1) G. The magnetic field points in z-direction and sets the quantization axis. Third, NaCs Feshbach molecules are transferred to the electronic, vibrational, and rotational ground state, X¹Σ⁺|v,J [symbol] =|0,0 [symbol] , via stimulated Raman adiabatic passage (STIRAP). The specific hyperfine state of ground state molecules is |m_{I}_{_{NA}}, m_{I}_{_{Cs}} [symbol] =|3/2, 5/2), where m_{I}_{_{NA}}(m_{I}_{_{Cs}}) is the projection of the nuclear spin of sodium (cesium) onto the quantization axis. Due to the large B field, the nuclear spin is decoupled from the rotational spin, such that hyperfine substructure does not need to be considered in the microwave shielding process. The STIRAP beams propagate vertically along the z-axis, parallel to gravity. In this way, the molecules remain inside the STIRAP beam profiles as they fall and expand in time-of-flight while shielded in the ground state to prevent losses. This is critical for precise thermometry of the molecular gas.

At the end of time-of-flight expansion, NaCs molecules are detected by ramping down the dressing fields (80 μs), reversing STIRAP (20 μs), performing optical dissociation with a pulse of light (100 μs) that is resonant with the Cs 6²S_{1/2}|F,m_{F} [symbol] =|3,3 [symbol] →6²P_{3/2}|5,5 [symbol] transition at high magnetic fields, immediately followed by absorption imaging of Cs atoms with a pulse of light (100 μs) that is resonant with the Cs6²S_{1/2}|4,4 [symbol] →6²P_{3/2}|5,5 [symbol] transition at high field. Here, F is the total atomic angular momentum and m_{F} its projection onto the quantization axis. The imaging resolution in the system is 4.5(5) μm (standard deviation of a Gaussian), comprised of a diffraction-limited resolution of 3 μm and momentum diffusion of about 3.5 μm of Cs atoms during the 100 μs imaging light pulse. The resolution is separately confirmed by measuring the smallest detectable cloud size for a small NaCs BEC.

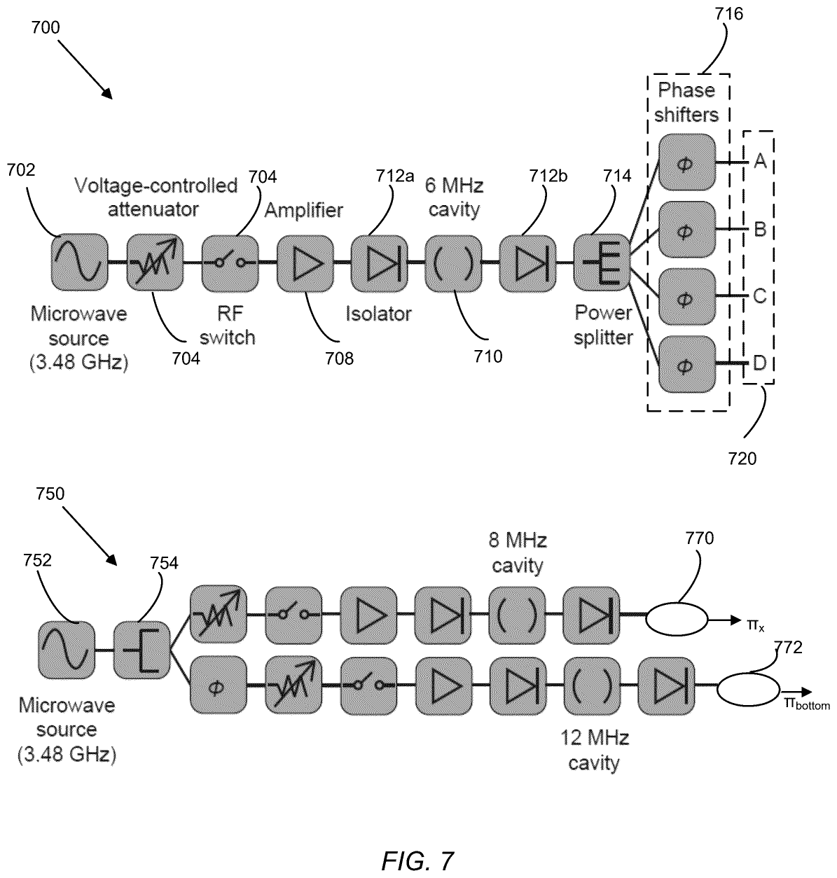

The setup to generate the microwave dressing fields includes a cloverleaf antenna array producing a circularly polarized σ⁺ field and two loop antennas, one producing the main linearly polarized (π) microwave field, and a second one to control the angle between the σ⁺ and π fields. The array and the loop antennas are implemented by two separate chains of microwave components, as illustrated in the block diagrams of FIG. 7. The first block diagram depicts a first microwave field generating chain 700 of microwave components producing σ⁺, whereas the second block diagram depicts a second microwave field generating chain 750 chain of microwave components producing the linearly polarized (π) microwave field.

The chain 700 culminates in an antenna array (that includes the antennas marked A, B, C, and D) that includes four resonant loop antennas in a cloverleaf configuration that are fed by a single microwave source 702. Phase shifts between the loops can be controlled (in a manner similar to that described in relation to FIG. 1D) using the stack of phase shifters 720 to generate clean circular polarization. In various examples, the cloverleaf antenna is oriented to emit along the vertical z-axis, with circular polarization in the xy-plane. A single loop antenna 770, of the chain 750, producing the main π field is oriented to emit on the horizontal x-axis, with linear polarization along the z-axis. A second loop antenna 772, of the chain 750, emits along the z-axis, and is used to align the polarization vector of the linear π field to the circularly polarized σ+ field. This is achieved by the careful tuning of the field's amplitude and phase. The molecules are prepared in the microwave-shielded dressed state by first adiabatically increasing the σ+ and then the π fields. Each intensity ramp is performed within 40 μs.

More specifically, the chain of microwave components to generate the σ⁺ is implemented as follows. The σ⁺ branch starts with, for example, a SG12000 signal generator (corresponding to the signal generator 702) from DS instruments. Its output is fed into a voltage-controlled attenuator 704 (e.g., General Microwave, D1954) followed by an RF switch 706 (e.g., Mini-Circuits, ZFSWA2R-63DR+). An amplifier 708 (e.g., RF Bay, JPA-1000-8000-5) is then used to reach the necessary high power. To reduce the phase noise of the amplifier, responsible for one-body loss of molecules due to transitions to unshielded states, its output is filtered by a 6 MHz bandwidth cavity 710 (e.g., WT Microwave, WT-A10140-Q04). To prevent potential reflections from the cavity that may damage the equipment, isolators 712a and 712b, such as Raditek, RADI-3.4-3.6-S3-10WR-10WFWD-H21, are used on each of the cavity's sides. The amplified and filtered signal is then split through a power splitter 714 (e.g., Mini-Circuits, ZN4PD1-63-S+) into four different branches, each connected to one of the four antennas of the array. By varying the length of the cable connecting the splitter to each antenna (labelled “phase shifters” in the above diagram), the relative 90° phase shifts that generate σ⁺ polarization are realized by phase shifters 716.

The π branch starts, for example, with a second SG12000 signal generator 752. Its output is immediately split into two branches by a splitter 754, one with a relative phase shift and attenuation with respect to the other given by a PS6000L phase shifter from DS instruments. The two branches then follow identical paths mirroring the σ⁺ branch, except that the two signals are not split into four but are directly fed into the two loop antennas 770 and 772.

As noted, the microwave chain is also used for controlling the angle between the σ+ generated by the microwave chain 700 and the π field generated by the first branch of the second microwave chain 750. Controlling the angle between the two fields is performed by measuring Rabi frequencies. To measure the π Rabi frequency, Ωπ, Rabi oscillations between |0,0 [symbol] and |1,0 [symbol] are observed. The σ⁺ Rabi frequency, Ωσ, is determined via dressed-state spectroscopy. Due to the use of narrow-bandwidth cavity filters in the microwave path the direct measurement of the resonant Rabi frequency is not possible. The probe field for the dressed-state spectroscopy is given by the σ⁺ output of the π antenna, which does not produce a perfectly pure linear polarization. To perform dressed-state spectroscopy, the σ+ field is initially increased to prepare the molecules in the |+ [symbol] dressed state (using the previously-discussed detuning). Then the field produced by the π antenna is tuned on abruptly for a time shorter than a π-pulse between the |+ [symbol] and |− [symbol] dressed states. By scanning the frequency of the probe field, the center frequency of the transition, ω, is determined, which in turn gives the σ⁺ Rabi frequency through the relation

$$ω - {ω}_{0} - {Δ}_{σ} = \sqrt{{Ω}_{σ}^{2} + {Δ}_{σ}^{2}} ,$$

where ω₀/2π is the known |0,0 [symbol] ↔|1,1 [symbol] transition frequency and Δ_{σ} is the known detuning from the same transition.

To determine the angle between the σ⁺ and π fields produced by the σ+ and π antennas. The knowledge of Ωπ is combined with the measurement of Rabi oscillations between the dressed states |+ [symbol] and |− [symbol] . Because the only allowed transitions between these states involve a σ+ photon, the Rabi frequency of the dressed state oscillation, Ω_{dressed}, reveals the projection of the π field onto the σ⁺ field. Thus, the angle between the vector normal to the σ⁺ field and π field is determined by arctan(Ω_{dressed})/(Ω_{π}sin²(ϕ)). The quantity sin²(ϕ) accounts for the relative strength of the dressed state sideband transitions, with ϕ determined, for example, using the relationship:

$$sin ( 2 ϕ ) = \frac{1}{\sqrt{1 + {( \frac{{Δ}_{σ}}{{Δ}_{σ}} )}^{2}}} .$$

From these measurements the tilt between the ϕ field and the vector normal to the σ⁺ field can be determined to be less than 1°. Since the fields need to be well aligned to ensure the full cancellation of the dipole moment, the size of the tilt angle sets the limit for how well the dipole moment can be compensated. The realization of a BEC requires relatively weak dipole-dipole interactions, so the tilt angle needs to be small.

The ellipticity of the σ⁺ field is determined through the direct measurement of the relative Rabi frequencies of the σ⁻ and σ⁺ transitions. The ellipticity of the π field can be inferred from the dressed state spectroscopy. As the projection of the π field onto the σ+ field is less than 1°, the ellipticity of the π field should also be less than 1°.

Thus, in conclusion, the use application described herein relates to creating a BEC of dipolar molecules. Leveraging the tunability of dipolar interactions, a dramatic suppression of losses is achieved while simultaneously creating the conditions for a weakly interacting Bose gas. With hundreds of molecules in an identical internal and motional state, the BEC is an ideal starting point for the exploration of strongly dipolar quantum matter. Thanks to its large dipole moment of 4.75 D, NaCs is ideally suited to tune between the weakly and strongly dipolar regime, which is hard to achieve in other dipolar systems, such as magnetic atoms or Rydberg atoms.

With the ability to create stable BECs, dipolar molecules make a significant leap towards becoming a new modality for quantum simulation, quantum information, and the exploration of novel many-body quantum systems. The BEC should give direct access to exotic forms of self-organization in 3D, such as the formation of droplet arrays and macro-droplets, predicted for densities and interaction strengths that can be reached from current conditions. In 2D systems, the emergence of strongly interacting superfluids, dipolar crystals, supersolid, and hexatic phases has been predicted. Furthermore, the BEC should be an ideal starting point to load optical lattices.

Stabilized through microwave shielding, achieved with the proposed loop antenna arrays described herein, the realization of extended Hubbard models with finite tunneling and wide tunability of interactions comes within reach, giving access to Mott insulators with fractional filling. In particular, it should become possible to realize the long-standing goal of loading optical lattices with unity filling, i.e., exactly one molecule per lattice site. This will be a critical prerequisite for the realization of spin models with hundreds of interacting spins. Combining the lattice loaded molecules with microwave dressing schemes, the formation of topologically-ordered phases or dipolar spin liquids may also come within reach.

### ADDITIONAL EMBODIMENTS

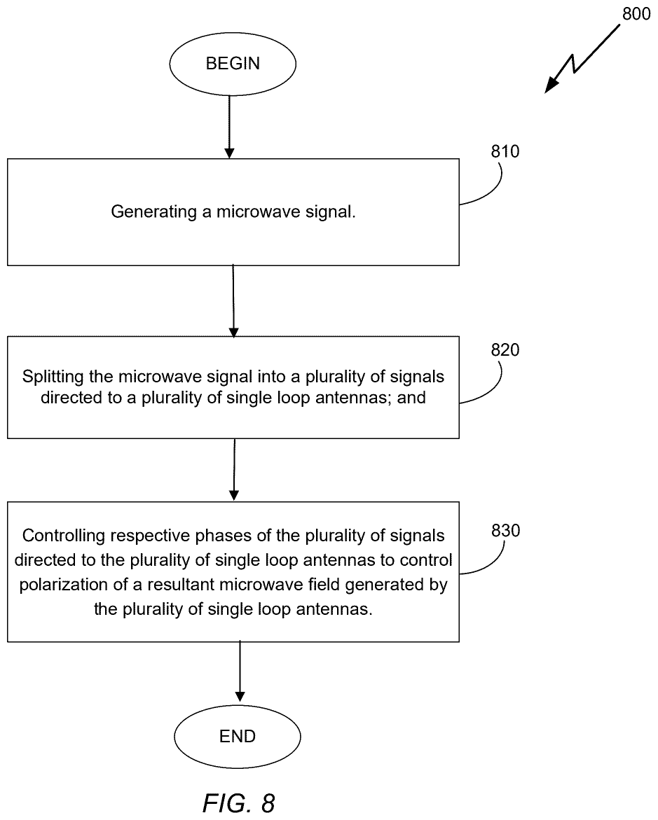

FIG. 8 is a flowchart of a procedure 800 for generating and applying microwave fields with desired characteristics (such as polarization configuration, e.g., circular, linear, etc.). The procedure 800 includes generating 810 a microwave signal, splitting 820 the microwave signal into a plurality of signals directed to a plurality of single loop antennas, and controlling 830 respective phases of the plurality of signals directed to the plurality of single loop antennas to control polarization of a resultant microwave field generated by the plurality of single loop antennas.

In various embodiments, splitting the microwave signal into the plurality of signals directed to the plurality of single loop antennas can include splitting the microwave signal into four signals directed to four single loop antennas mounted on a holding structure defining a cloverleaf shaped antenna array arrangement. In such embodiments, controlling the respective phases of the plurality of signals may include controlling the phases of the plurality of signals to produce a circularly-polarized σ+ field applied to a sample of molecules in a magnetic trap.

The procedure 800 may further include generating another microwave signal, splitting the other microwave signal into another plurality of signals directed to another plurality of single loop antennas to produce a linear π field at a desired orientation relative to the σ+ field, and applying the linear π field, together with the circularly-polarized σ+ field, to the sample of molecules to suppress collisional losses in the sample of molecules so as to cause evaporative cooling of the sample of molecules that produces Bose-Einstein condensate of at least some molecules in the sample of molecules. In some examples, the procedure 800 may further include applying the circularly-polarized σ+ field to a bosonic gas sample comprising strongly dipolar NaCs molecules to achieve low inelastic loss rates for the bosonic gas sample.

In some embodiments, splitting the microwave signal into the plurality of signals directed to the plurality of single loop antennas may include splitting the microwave signal into four signals directed to four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other. The semi-major axes of the first pair of single loop antennas can be oriented substantially perpendicularly to the semi-major axes of the second pair of single loop antennas.

Performing the various techniques and operations described herein may be facilitated, in part, by a controller device (e.g., a processor-based computing device). Such a controller device may include a processor-based device such as a computing device, and so forth, that typically includes a central processor unit (CPU) or a processing core. The device may also include one or more dedicated learning machines (e.g., neural networks) that may be part of the CPU processing core. In addition to the CPU or processing core, the system includes main memory, cache memory and bus interface circuits. The controller device may include a memory storage device, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, control operations to generate a microwave field that can be applied, for instance, to shield and stabilizing sample of ultracold molecules (e.g., NaCs) image reconstruction from MR k-space data. The storage device of the controller device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A microwave antenna array comprising:
a plurality of single loop antennas mounted on a holding structure; and
a phase tuner to control the phases of signals radiated by each of the plurality of single loop antennas to control polarization of a resultant microwave field generated by the plurality of single loop antennas.

2. The microwave antenna array of claim 1, wherein the plurality of single loop antennas comprises four single loop antennas mounted on the holding structure to define a cloverleaf shaped antenna array arrangement.

3. The microwave antenna array of claim 1, wherein the phase tuner comprises:
cable length adjusters to control effective lengths of respective cables carrying signals to the plurality of the single loop antennas.

4. The microwave antenna array of claim 3, wherein the cable length adjusters comprise SMA adapters.

5. The microwave antenna array of claim 1, wherein the plurality of single loop antennas comprise four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other, wherein the semi-major axes of the first pair of single loop antennas are oriented substantially perpendicularly to the semi-major axes of the second pair of single loop antennas.

6. The microwave antenna array of claim 5, wherein when activated, the first pair of opposing single loop antennas generates a microwave field linearly polarized along a first axis of a three-dimensional space, and the second pair of opposing single loop antennas generates a microwave field linearly polarized along a second axis of the three-dimensional space.

7. The microwave antenna array of claim 6, wherein the phase tuner is configured to set the relative phase difference between the first pair of opposing single loop antennas and the second pair of opposing single loop antennas to one of −π/2 or π/2 to cause a left circular polarization of the microwave field generated by the microwave antenna array.

8. A microwave field generating system comprising:
a microwave antenna array that includes:
a plurality of single loop antennas mounted on a holding structure; and
a phase tuner to control the phases of signals radiated by each of the plurality of single loop antennas to control polarization of a resultant microwave field generated by the plurality of single loop antennas; and
a microwave field controller to control properties of microwave signals provided to the phase tuner.

9. The system of claim 8, wherein the plurality of single loop antennas comprises four single loop antennas mounted on the holding structure to define a cloverleaf shaped antenna array arrangement.

10. The system of claim 8, wherein the phase tuner comprises:
cable length adjusters to control effective lengths of respective cables carrying signals to the plurality of the single loop antennas.

11. The system of claim 8, wherein the plurality of single loop antennas comprises four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other, wherein the semi-major axes of the first pair of single loop antennas are oriented substantially perpendicularly to the semi-major axes of the second pair of single loop antennas.

12. The system of claim 8, wherein the microwave field controller comprises:
a microwave generator to generate a microwave signal;
a voltage-controlled attenuator to control a voltage level of the microwave signal to produce a voltage-controlled microwave signal;
a microwave switch with at least one input port to receive the voltage-controlled microwave signal, and at least one output port to controllably provide an output microwave signal for downstream transmission of the voltage-controlled microwave signal; and
a splitter to split the output microwave signal into a plurality of paths for the respective ones of the plurality of single loop antennas.

13. The system of claim 8, wherein the phase tuner comprises:
adaptors to control effective lengths of respective cables carrying signals to the plurality of the single loop antennas; and
amplifiers to amplify each of the signals transmitted to the plurality of single loop antennas.

14. The system of claim 8, further comprising:
a target sample on which the resultant microwave field is applied.

15. A method for producing microwave radiation, the method comprising:
generating a microwave signal;
splitting the microwave signal into a plurality of signals directed to a plurality of single loop antennas; and
controlling respective phases of the plurality of signals directed to the plurality of single loop antennas to control polarization of a resultant microwave field generated by the plurality of single loop antennas.

16. The method of claim 15, wherein splitting the microwave signal into the plurality of signals directed to the plurality of single loop antennas comprises:
splitting the microwave signal into four signals directed to four single loop antennas, mounted on a holding structure, defining a cloverleaf shaped antenna array arrangement.

17. The method of claim 16, wherein controlling the respective phases of the plurality of signals comprises:
controlling the phases of the plurality of signals to produce a circularly-polarized σ⁺ field applied to a sample of molecules in a magnetic trap.

18. The method of claim 17, further comprising:
generating another microwave signal;
splitting the other microwave signal into another plurality of signals directed to another plurality of single loop antennas to produce a linear π field at a desired orientation relative to the σ⁺ field; and
applying the linear π field, together with the circularly-polarized σ⁺ field, to the sample of molecules to suppress collisional losses in the sample of molecules so as to cause evaporative cooling of the sample of molecules that produces Bose-Einstein condensate of at least some molecules in the sample of molecules.

19. The method of claim 17, further comprising:
applying the circularly-polarized σ+ field to a bosonic gas sample comprising strongly dipolar NaCs molecules to achieve low inelastic loss rates for the bosonic gas sample.

20. The method of claim 15, wherein splitting the microwave signal into the plurality of signals directed to the plurality of single loop antennas comprises:
splitting the microwave signal into four signals directed to four elliptical-shaped single loop antennas arranged in a cloverleaf-shaped configuration that includes a first pair of opposing single loop antennas whose semi-major axes are parallel to each other, and a second pair of opposing single loop antennas whose semi-major axes are parallel to each other, wherein the semi-major axes of the first pair of single loop antennas are oriented substantially perpendicularly to the semi-major axes of the second pair of single loop antennas.
